(19) United States
(12) Patent Application Publication
(10) Pub. No.: US 2022/0374801 A1
(43) Pub. Date: Nov. 24, 2022

(54) PLAN EVALUATION APPARATUS AND PLAN EVALUATION METHOD

(71) Applicant: Hitachi, Ltd., Tokyo (JP)

(72) Inventors: Yuta TSUCHIYA, Tokyo (JP); Yasuhide MORI, Tokyo (JP); Masashi EGI, Tokyo (JP)

(21) Appl. No.: 17/692,237

(22) Filed: Mar. 11, 2022

(30) Foreign Application Priority Data
May 24, 2021 (JP) 2021-086680

(51) Int. Cl. G06Q 10/06

(52) U.S. Cl. CPC G06Q 10/06312; G06Q 10/06315; G06Q 10/06393; G06Q 10/063112

(57) ABSTRACT

A plan evaluation apparatus, which evaluates a schedule planned by combining a plurality of plans, includes: a feature conversion unit that divides the schedule into plan components based on a predetermined conversion rule, and convert the divided plan components into features; a model learning unit that uses the features as an input and creates a machine learning model having a key performance indicator (KPI) of the schedule as an objective variable; a contribution rate calculation unit that calculates a contribution rate of each of the features with respect to the machine learning model; and an influence degree calculation unit that calculates an influence degree of influence, on the KPI of the schedule, of the plan component which is a conversion source of the feature, based on the contribution rate of the feature.

### CROSS-REFERENCE TO RELATED APPLICATION

The present application claims priority from Japanese application JP2021-086680, filed on May 24, 2021, the contents of which is hereby incorporated by reference into this application.

### BACKGROUND OF THE INVENTION

### 1. Field of the Invention

The present invention relates to a plan evaluation apparatus and a plan evaluation method, and is suitable when being applied to a plan evaluation apparatus and an operation plan evaluation method for assisting planning, evaluating a plan, and extracting information of a plan.

### 2. Description of the Related Art

In creating operation plans such as a product production plan and an employee shift schedule, it is necessary to create a schedule in consideration of an evaluation index (key performance indicator (KPI)) of a plan, such as maximization of output, maximization of capacity utilization, and minimization of the number of workers while complying with constraint conditions regarding various items such as time, space, equipment, and resources such as people. Conventionally, employees (workers) having such advanced know-how have created schedules, but there are increasing cases where a plan creation apparatus using a computer is created and is made to perform automatic planning while considering the above conditions from the viewpoint of shortage of successors and improvement of operation efficiency.

On the other hand, constraint conditions and KPIs in planning of a schedule are extremely many, and affect each other in a complicated manner. Therefore, it sometimes takes a lot of man-hours to develop the plan creation apparatus, and there is a demand for reduction of the man-hours. One of causes of the increase in man-hours is that work time required to evaluate a planned schedule, find a drawback, and examine a revision. Evaluation methods include a quantitative method based on a numerical value of a KPI and the degree of violation of a constraint condition, and a method of visually confirming the schedule for finding an unintended bug or finding a condition that is not formulated as compared with a plan of a worker. However, in some cases, the schedule is extremely large with several thousand items or more so that it is sometimes difficult to visually confirm the schedule.

With regard to a technique for assisting evaluation of a schedule as described above, JP 2019-209796 A describes a method including: calculating an overall evaluation value of a schedule by superimposing a plurality of partial evaluation components; extracting a partial evaluation component having a large contribution degree in a direction of degrading the overall evaluation value; and extracting a component of the schedule that contributes to the overall evaluation value in the most undesirable direction, when the partial evaluation component is calculated by superimposing smaller partial evaluation components, by repeating the operation of extracting a partial evaluation component that greatly contributes in the similar way.

Further, a method of expressing a combination serving as a decision variable in each plan, such as producing/not producing a certain product, using a dummy variable of (0, 1) is described as a generic technology for numerically evaluating a schedule in Christian D. Hubbs, Can Li, Nikolaos V. Sahinidis, Ignacio E. Grossmann, John M. Wassick, “A deep reinforcement learning approach for chemical production scheduling,” Computers and Chemical Engineering, 106982, vol. 141, (2020).

Further, a method for calculating a contribution rate with respect to a prediction value of AI for each feature, which is a simple numerical sequence, using sets of a plurality of pieces of perturbation data generated by changing data to be evaluated and prediction values obtained by inputting the respective pieces of perturbation data to the AI in the field of AI models such as machine learning is described in Lundberg, Scott M., and Su-In Lee, “A unified approach to interpreting model predictions,” Advances in Neural Information Processing Systems, pp. 4765-4774, (2017).

### SUMMARY OF THE INVENTION

However, the technique described in JP 2019-209796 A has a problem that only a KPI allowing partial evaluation can be analyzed. The partial evaluation means that evaluation is performed individually after dividing a schedule. Further, it is necessary for an evaluator to designate a schedule division rule for the partial evaluation, which requires additional man-hours. Furthermore, an eventually obtained plan component is a component that directly degrades a value of the KPI, but there is also a component that indirectly affects the KPI by affecting other plan components without directly changing the KPI since the components of the schedule complicatedly affect each other. However, the technology of JP 2019-209796 A has a problem that it is difficult to extract a component that does not directly change the KPI.

Further, in a case where the schedule is described by the technology described in Christian D. Hubbs, Can Li, Nikolaos V. Sahinidis, Ignacio E. Grossmann, John M. Wassick, “A deep reinforcement learning approach for chemical production scheduling,” Computers and Chemical Engineering, 106982, vol. 141, (2020), it is necessary to create dummy variables for all possible combinations, and there is a problem that the schedule has a high-dimensional and sparse data structure and is very difficult to handle.

Further, the technique described in Lundberg, Scott M., and Su-In Lee, “A unified approach to interpreting model predictions,” Advances in Neural Information Processing Systems, pp. 4765-4774, (2017) has a problem that the contribution rate with respect to the prediction of the feature, which is the simple numerical sequence, can be calculated, but is not directly applicable to the schedule evaluation.

The present invention has been made in view of the above points, and aims to propose a plan evaluation apparatus and a plan evaluation method capable of extracting, from a schedule, a component having a large influence degree directly or indirectly on even a KPI not allowing partial evaluation by expanding a method of calculating an influence degree of a feature in a machine learning model to evaluation of a schedule.

In order to solve such a problem, the present invention provides a plan evaluation apparatus, which evaluates a schedule planned by combining a plurality of plans, includes: a feature conversion unit that divides the schedule into plan components based on a predetermined conversion rule, and convert the divided plan components into features; a model learning unit that uses the features as an input and creates a machine learning model having a key performance indicator (KPI) of the schedule as an objective variable; a contribution rate calculation unit that calculates a contribution rate of each of the features with respect to the machine learning model; and an influence degree calculation unit that calculates an influence degree of influence, on the KPI of the schedule, of the plan component which is a conversion source of the feature, based on the contribution rate of the feature.

In order to solve such a problem, the present invention provides a plan evaluation method by a plan evaluation apparatus, which evaluates a schedule planned by combining a plurality of plans. The plan evaluation method including: a feature conversion step of dividing, by the plan evaluation apparatus, the schedule into plan components based on a predetermined conversion rule, and convert the divided plan components into features; a model learning step of receiving, by the plan evaluation apparatus, an input of the feature converted in the feature conversion step and creating a machine learning model having a key performance indicator (KPI) of the schedule as an objective variable; a contribution rate calculation step of calculating, by the plan evaluation apparatus, a contribution rate of each of the features with respect to the machine learning model created in the model learning step; and an influence degree calculation step of calculating, by the plan evaluation apparatus, an influence degree of influence, on the KPI of the schedule, of the plan component which is a conversion source of the feature, based on the contribution rate of the feature calculated in the contribution rate calculation step.

According to the present invention, in the evaluation of the schedule, it is possible to extract, from the schedule, the component having a large influence degree directly or indirectly on the KPI not allowing the partial evaluation.

### BRIEF DESCRIPTION OF THE DRAWINGS

FIG. 1 is a block diagram illustrating a configuration example of a plan evaluation apparatus 1000 according to a first embodiment of the present invention;

FIG. 2 is a view illustrating an example of an evaluation index list 1013;

FIG. 3 is a view illustrating an example of a schedule 1014;

FIG. 4 is a view illustrating an example of KPI data 1015;

FIG. 5 is a flowchart illustrating an example of a processing procedure of an influence degree calculation process;

FIG. 6 is a view illustrating an example of a feature conversion rule 1022;

FIG. 7 is a flowchart illustrating an example of a processing procedure of a feature conversion process;

FIG. 8 is a view for describing an image of compression and conversion in the feature conversion process;

FIG. 9 is a view illustrating an example of a plan feature table 1023;

FIG. 10 is a view illustrating an example of a contribution rate calculation result 1024;

FIG. 11 is a flowchart illustrating an example of a processing procedure of influence degree information aggregation process;

FIG. 12 is a view illustrating an example of an influence degree calculation result 1025;

FIG. 13 is a view for describing an image of a process of distributing and integrating contribution rates;

FIG. 14 is a view illustrating an example of an output screen based on the influence degree calculation result 1025;

FIG. 15 is a flowchart illustrating an example of a processing procedure of an influence degree calculation process by an integration model;

FIG. 16 is a view for describing an image of a process of calculating an influence degree in the influence degree calculation process by the integration model;

FIG. 17 is a block diagram illustrating a configuration example of a plan evaluation apparatus 1700 according to a second embodiment of the present invention;

FIG. 18 is a flowchart illustrating an example of a processing procedure of a first indirect influence relationship extraction process;

FIG. 19 is a view for describing an image of a process of searching for an indirect influence relationship;

FIG. 20 is a view illustrating an example of the influence degree calculation result 1025 including the indirect influence relationship; and

FIG. 21 is a flowchart illustrating an example of a processing procedure of a second indirect influence relationship extraction process.

### DESCRIPTION OF THE PREFERRED EMBODIMENTS

Hereinafter, embodiments of the present invention will be described with reference to the drawings.

Hereinafter, only the evaluation of a personnel assignment plan for assigning a request to an appropriate employee will be described, but a plan evaluation method according to the present invention can be widely applied to a system in which it is necessary to create and change a plan by combining various evaluation viewpoints in a complex manner, such as an operational plan of a transportation, such as an aircraft, a bus, and a railway, a product manufacturing plan in a factory, and the like.

Further, the respective embodiments to be described hereinafter are merely examples for realizing the present invention and do not limit a technical scope of the present invention. Those skilled in the art can easily understand that specific configurations can be changed without departing from the spirit or gist of the present invention.

In the configurations of the invention to be described hereinafter, the same or similar configurations or functions will be denoted by the same reference signs, and redundant descriptions will be omitted. Further, some or all of the above-described configurations, functions, processing units, processing means, and the like described in the respective embodiments may be realized, for example, by hardware by designing with an integrated circuit and the like. Further, each of the above-described configurations, functions, and the like may also be realized by software by causing a processor to interpret and execute a program for realizing each of the functions. Information such as programs, tables, and files that realize the respective functions can be installed in a recording device such as a memory, a hard disk, and a solid state drive (SSD), or a recording medium such as an IC card, an SD card, and a DVD.

Further, positions, sizes, shapes, ranges, and the like of the respective components illustrated in the drawings and the like do not always indicate actual positions, sizes, shapes, ranges and the like in order to facilitate understanding of the invention. In the above drawings, control lines and information lines are considered to be necessary for the description have been illustrated, and it is difficult to say that all of the control lines and information lines required as a product are illustrated. It may be considered that most of configurations are practically connected to each other. Therefore, the invention is not limited to the positions, sizes, shapes, ranges, and the like disclosed in the drawings and the like.

### (1) First Embodiment

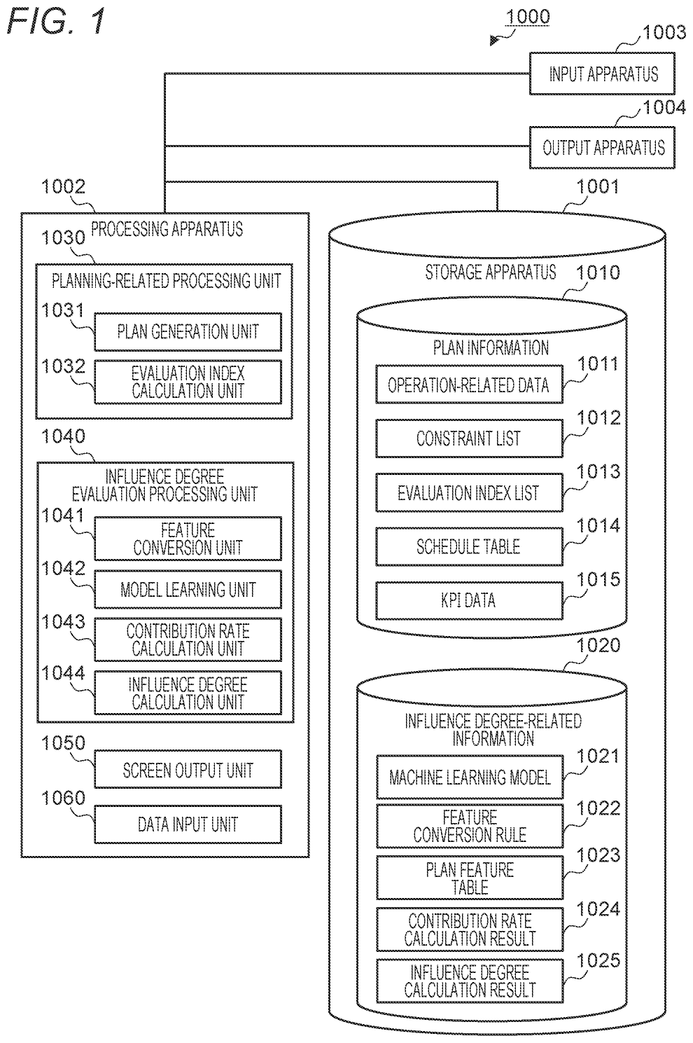

FIG. 1 is a block diagram illustrating a configuration example of a plan evaluation apparatus 1000 according to a first embodiment of the present invention. As illustrated in FIG. 1, a plan evaluation apparatus 1000 includes a storage apparatus 1001, a processing apparatus 1002, an input apparatus 1003, and an output apparatus 1004.

The storage apparatus 1001 is a general-purpose apparatus that permanently stores data, such as a hard disk drive (HDD) and a solid state drive (SSD), and includes plan information 1010 and influence-degree-related information 1020. Note that the storage apparatus 1001 may be configured on a terminal similar to the other apparatuses constituting the plan evaluation apparatus 1000, or may be configured to exist on a cloud or an external server instead of on the same terminal as the other apparatuses described above, and refer to data via a network.

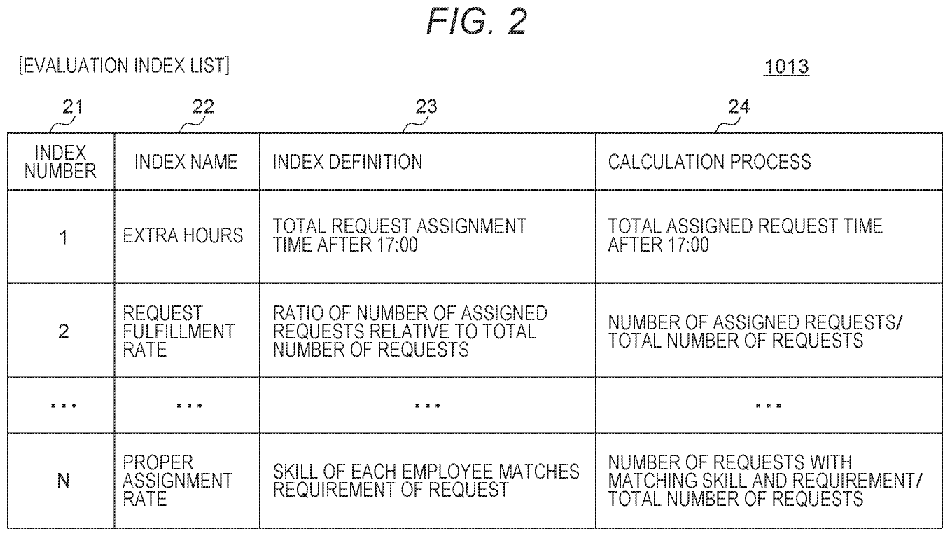

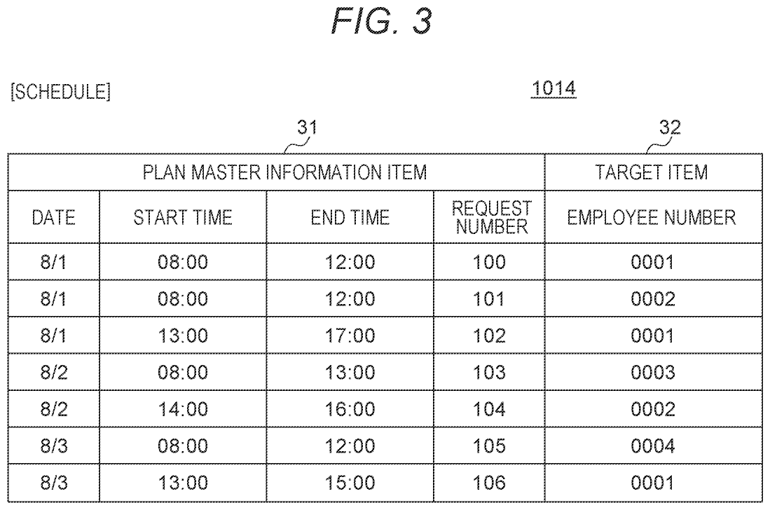

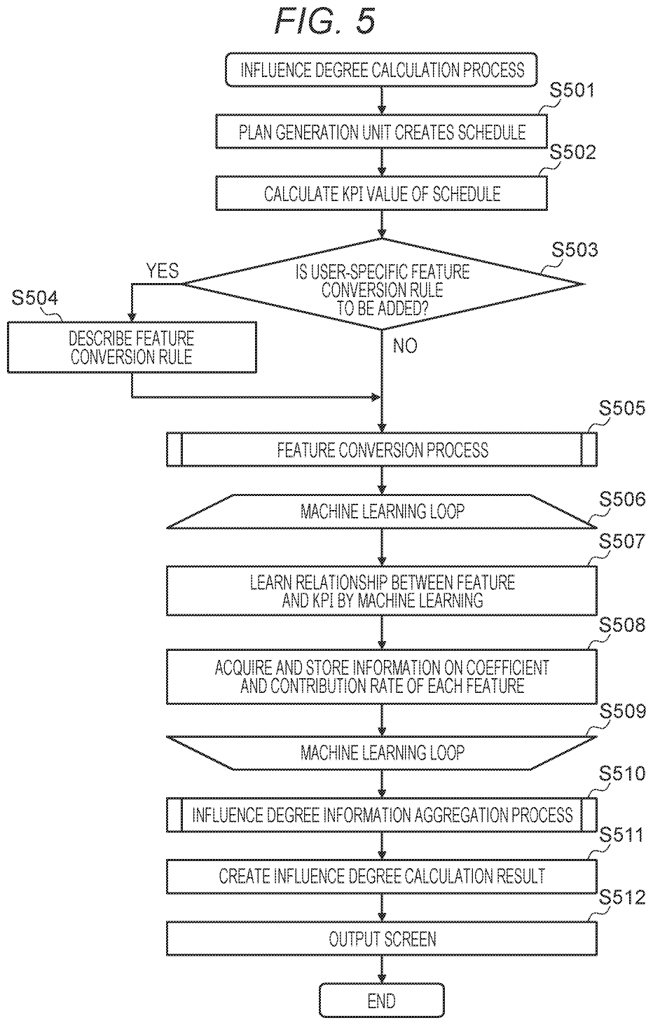

The plan information 1010 includes: operation-related data 1011 serving as an input to generate a schedule made by combining a plurality of plans; a constraint list 1012; an evaluation index list 1013 (see FIG. 2 for details); a schedule 1014 to be evaluated (see FIG. 3 for details); and KPI data 1015 (see FIG. 5 for details) which is an evaluation result. In this text, an evaluation index and a key performance indicator (KPI) are synonymous.

Examples of the operation-related data 1011 include skill information and request assignable time information of an employee, time information on the date, start, and end of an assigned request, skill condition information, and other master information.

The constraint list 1012 is data storing constraint conditions that the schedule 1014 needs to follow, for example, whether a request is not assigned to an unassignable time of an employee, whether overtime is not a prescribed value or more, and the like, and is used to generate a plan.

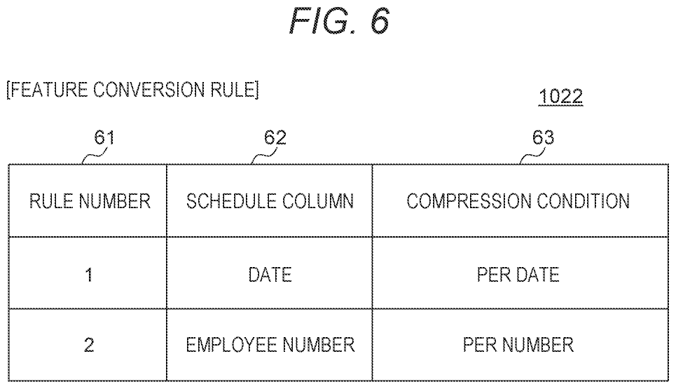

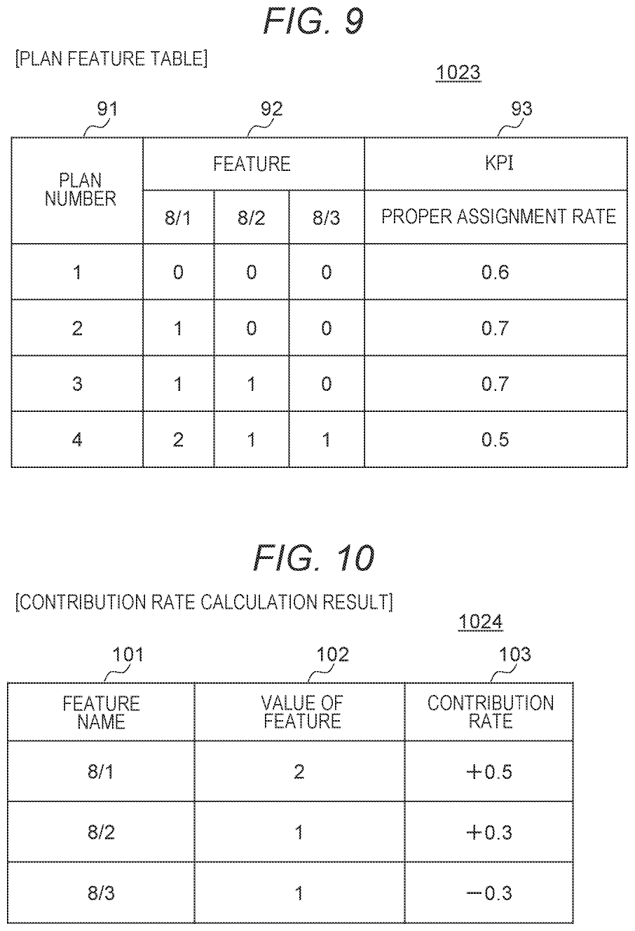

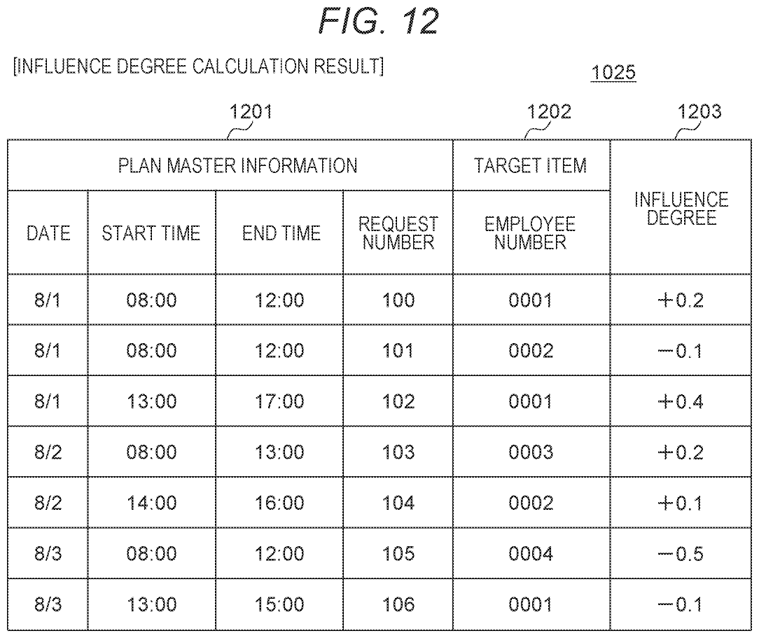

The influence-degree-related information 1020 includes: a machine learning model 1021 that learns an influence relationship between the schedule 1014 and the KPI; a feature conversion rule 1022 (see FIG. 6 for details) that holds rules for converting components of the schedule 1014 in order to input the schedule 1014 into the model (machine learning model 1021); a plan feature table 1023 (see FIG. 9 for details) that holds a feature obtained by converting the schedule 1014; a contribution rate calculation result 1024 (see FIG. 10 for details) that holds a calculation result of a contribution rate of a feature with respect to the machine learning model 1021; and an influence degree calculation result 1025 (see FIG. 12 for details) that holds an influence degree calculation result.

The processing apparatus 1002 is, for example, a general-purpose computer including a central processing unit (CPU), a memory, and the like. The processing apparatus 1002 includes a planning-related processing unit 1030, an influence degree evaluation processing unit 1040, a screen output unit 1050, and a data input unit 1060 therein in a form of storing these in a memory as software programs or the like.

The planning-related processing unit 1030 includes: a plan generation unit 1031 that receives an input of data of the storage apparatus 1001 and outputs the schedule 1014; and an evaluation index calculation unit 1032 that evaluates the obtained schedule 1014 and outputs a KPI value.

The influence degree evaluation processing unit 1040 includes a feature conversion unit 1041 that converts the schedule 1014 automatically or based on the feature conversion rule 1022 to obtain the plan feature table 1023, a model learning unit 1042 that generates the machine learning model 1021, a contribution rate calculation unit 1043 that obtains a contribution rate of a feature in the model (machine learning model 1021), and an influence degree calculation unit 1044 that extracts an influence portion of the schedule 1014 on the KPI.

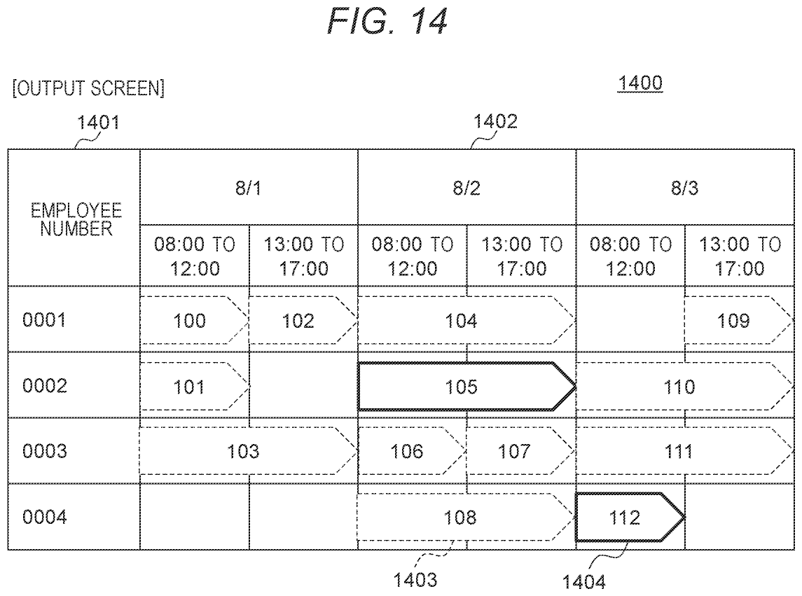

The screen output unit 1050 has a function of outputting information for causing the output apparatus 1004 to display a predetermined screen. Specifically, for example, the screen output unit 1050 generates information for screen display based on the influence degree calculation result 1025 calculated by the influence degree calculation unit 1044, and transmits the information to the output apparatus 1004. As a result, the output apparatus 1004 displays an output screen based on the influence degree calculation result 1025 (see FIG. 14).

The data input unit 1060 has a function of inputting a processing execution instruction and data according to an input operation with respect to the input apparatus 1003 performed by a developer (thereafter, user), and is utilized when the user makes a change to a schedule or sets a parameter. Specifically, for example, in a case where a user-specific feature conversion rule is designated, the data input unit 1060 receives the feature conversion rule from the input apparatus 1003 operated by the user, and stores the feature conversion rule in the storage apparatus 1001 as the feature conversion rule 1022.

The input apparatus 1003 is a general-purpose input apparatus for a computer, and is, for example, a mouse, a keyboard, a touch panel, or the like.

The output apparatus 1004 is an apparatus such as a display, and displays the output screen representing an evaluation result (for example, the influence degree calculation result 1025) obtained by the processing apparatus 1002 via the screen output unit 1050. In a case where it is unnecessary for a person to confirm an evaluation result obtained by the processing apparatus 1002 (for example, in a case where an evaluation result is directly delivered to a system that automatically makes a plan), the output apparatus 1004 is not necessarily provided in the plan evaluation apparatus 1000.

FIG. 2 is a view illustrating an example of the evaluation index list 1013. The evaluation index list 1013 is a database including: an index number 21 in which a number assigned to each index is stored; an index name 22 in which a name of an evaluation index related to the index number is stored; an index definition 23 in which a definition content of the evaluation index related to the index number is store; and a calculation process 24 of a value of the evaluation index related to the index number. The evaluation index list 1013 is, for example, information input by the user or acquired from a predetermined information processing apparatus.

FIG. 3 is a view illustrating an example of the schedule 1014. The schedule 1014 illustrated in FIG. 3 is a schedule (target schedule) to be evaluated, and specifically, is data to be subjected to calculation of an influence degree in an influence degree calculation process to be described later with reference to FIG. 5.

The schedule 1014 is configured as matrix data (table data), and is divided into fixed plan master information 31 common to all schedules and target items 32 unique to the schedules, respectively. Types of the schedule 1014 will be described later.

The plan master information 31 stores basic information of a schedule such as the date, start time and end time of a request, and a request number. Data of each item of the plan master information 31 is output from the operation-related data 1011 and stored in the schedule 1014.

The target item 32 stores information unique to the schedule. A combination of the target items 32 is determined by the plan generation unit 1031 so as to optimize a value in the evaluation index list 1013 while satisfying a condition in the constraint list 1012. For example, in a case where the plan evaluation apparatus 1000 evaluates a personnel assignment plan, the target item 32 is an employee number, and the evaluation of the personnel assignment plan is a combinatorial problem for determining the assignment of an employee to a predetermined request as illustrated in the example of FIG. 3.

As described above, any problem in the schedule 1014 for obtaining a combination of certain items is subjected to the evaluation by the plan evaluation apparatus 1000. Further, the plan component described in the present invention refers to one row in the schedule 1014. Then, “calculating an influence degree of a schedule on a KPI” refers to “extracting a plan component that has greatly contributed to a change of a KPI in a certain schedule”.

Note that three types of the schedules 1014 including a target schedule, a historical schedule, and a reference schedule are used in the present embodiment. In all the schedules, the plan master information 31 is common, and the target items 32 contain different or identical items.

The target schedule is a schedule that is subjected to calculation and analysis of an influence degree, and is generated by S501 in FIG. 5 to be described later.

The historical schedule is a schedule generated in advance (generated in the past) in a different process from the target schedule. The process of generating the historical schedule is manual work by a worker, a plan generation algorithm different from that of the target schedule, or what is obtained by utilizing the randomness of the same algorithm as the target schedule, and it suffices that the generated historical schedule has the same plan master information 31 as the target schedule and the target item 32 having the same format as the target schedule. The historical schedule is a schedule useful to enhance the accuracy of calculation of an influence degree on the target schedule.

The reference schedule may be considered as a type of historical schedule, and is a schedule to be clearly compared with the target schedule. The reference schedule corresponds to, for example, a schedule as a sample created by a worker or a schedule created by a plan generation algorithm before performing certain correction work.

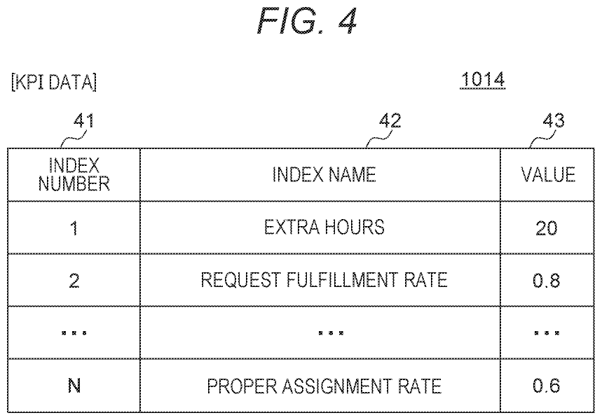

FIG. 4 is a view illustrating an example of the KPI data 1015. The KPI data 1015 is data that stores a result (KPI value) obtained by evaluating the schedule 1014 based on the evaluation index list 1013. The KPI data 1015 exists for each of the various schedules, that is, the target schedule, the historical schedule, and the reference schedule.

The KPI data 1015 is a database including: an index number 41 in which a number assigned to each index is stored; an index name 42 in which a name of an evaluation index related to the index number 41 is stored; and a value 43 of an evaluation result. The number stored in the index number 41 corresponds to the number of the index number 21 in the evaluation index list 1013 of FIG. 2. The value 43 stores a KPI value such as a numerical value, a binary value, and a category value. Further, the KPI data 1015 has a one-to-one correspondence with the schedule 1014, which is a calculation source of the evaluation result, and a correspondence relationship between the schedule 1014 and the KPI data 1015 can be distinguished by a file name or the like.

Hereinafter, the influence degree calculation process of calculating an influence degree of a target schedule will be described with reference to the drawings as appropriate.

FIG. 5 is a flowchart illustrating an example of a processing procedure of the influence degree calculation process. In the present embodiment, the plan evaluation apparatus 1000 executes the influence degree calculation process to compress and convert components of the schedule 1014 into a feature format, which is a simple numerical sequence, and creates the machine learning model 1021 learning a relationship between the obtained feature and a KPI value. Furthermore, the plan evaluation apparatus 1000 calculates a contribution rates, with respect to outputs, of features in the obtained machine learning model 1021 and distributes the contribution rates to components of a target schedule and integrates the contribution rates, thereby calculating an influence degrees of influence, on the KPI value, of the component of the target schedule.

According to FIG. 5, the plan generation unit 1031 of the processing apparatus 1002 first reads the operation-related data 1011 and the constraint list 1012 from the storage apparatus 1001 and generates a target schedule (step S501). The target schedule generated in step S501 is, for example, the schedule 1014 illustrated in FIG. 3, and is stored in the storage apparatus 1001. Note that a specific method, used by the plan generation unit 1031 to generate the target schedule in step S501, may be any method of obtaining a combination solution of the target items 32 while considering a constraint condition such as a combinatorial optimization solver and a machine learning model.

Next, the evaluation index calculation unit 1032 receives inputs of the evaluation index list 1013 and the target schedule (schedule 1014) output in step S501, calculates the KPI value of the target schedule, and stores the KPI data 1015 indicating the calculation result in the storage apparatus 1001 (step S502). In a case where the plan generation unit 1031 and the evaluation index calculation unit 1032 are configured by the same program or the same architecture, the processes of steps S501 and S502 are executed at the same time.

Next, when performing feature conversion to input each schedule to the model learning unit 1042, the user selects whether to introduce the user-specific feature conversion rule 1022 (step S503). If the introduction of the user-specific feature conversion rule 1022 has not been selected in step S503, it is assumed that an automatic rule for automatically converting a schedule into a feature is used in the feature conversion, and the process proceeds to step S505.

On the other hand, if the introduction of the user-specific feature conversion rule 1022 has been selected in step S503 (YES in step S503), the user operates the input apparatus 1003 to describe the feature conversion rule 1022 to be introduced (step S504). Details of a method for describing the feature conversion rule 1022 will be described later with reference to FIG. 6. Then, the data input unit 1060 stores the described feature conversion rule 1022 in the storage apparatus 1001, and then, the process proceeds to step S505.

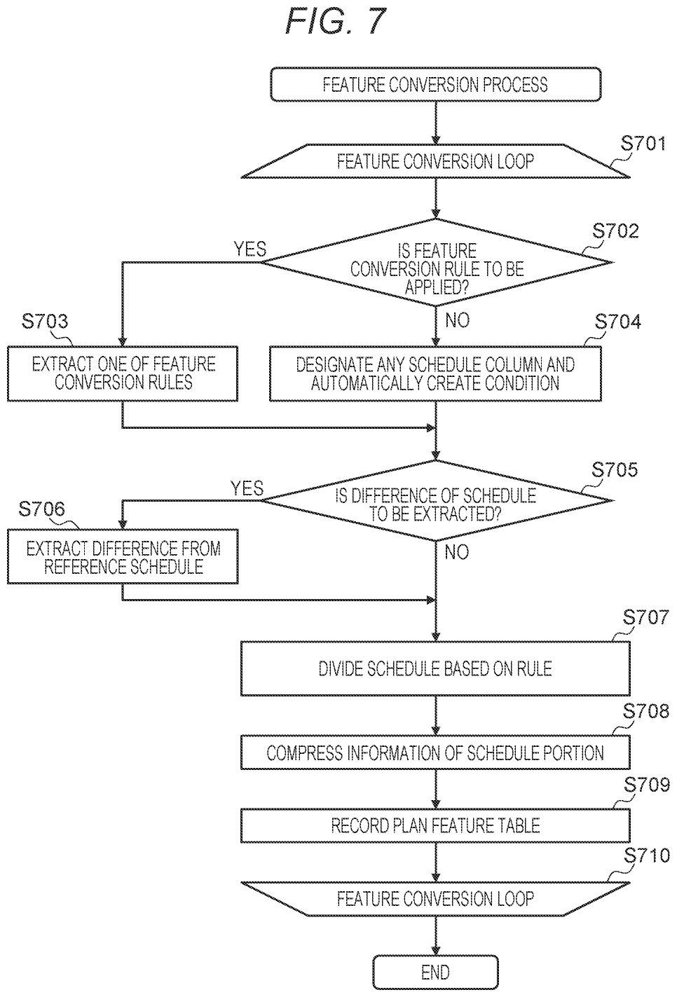

In step S505, the feature conversion unit 1041 receives inputs of the target schedule generated in step S501, a historical schedule obtained in the past, and the KPI values (KPI data 1015) of the target schedule and the historical schedule, and executes a feature conversion process of executing, a plurality of times, conversion into a feature of the target schedule using the feature conversion rule 1022 or the automatic rule selected in steps S503 and S504 or a combination of the feature conversion rule 1022 and the automatic rule. Although a detailed processing procedure of the feature conversion process will be described later with reference to FIG. 7, the feature conversion unit 1041 stores the features, obtained by converting the schedule in the feature conversion process, in the storage apparatus 1001 as the plan feature table 1023.

Next, in step S506, the influence degree evaluation processing unit 1040 selects one of a plurality of the plan feature tables 1023 obtained in the feature conversion process in step S505, and starts machine learning loop processing.

In the machine learning loop processing, in step S507, the model learning unit 1042 first performs machine learning with the plan feature table 1023 selected in step S506 as an input and the KPI data 1015 (which may be read as a KPI 93 of the plan feature table 1023) corresponding to the plan feature table 1023 as an output (objective variable), thereby creating the machine learning model 1021 that has learned a relationship between each schedule and the KPI data 1015. The machine learning model 1021 created in step S507 is stored in the storage apparatus 1001. Note that the machine learning model 1021 created by the model learning unit 1042 is assumed to be based on a decision tree or a neural network, which is supervised learning in which processing on input data is executed to output a prediction value.

In the next step S508, the contribution rate calculation unit 1043 calculates a contribution rate of each feature based on the machine learning model 1021 created in step S507, the plan feature table 1023 selected in step S506, and the KPI data 1015 corresponding to the plan feature table 1023, and stores information indicating the calculation result (contribution rate calculation result 1024) in the storage apparatus 1001.

As a method for calculating the contribution rate by the contribution rate calculation unit 1043, it is possible to apply, for example, a method described in Lundberg, Scott M., and Su-In Lee, “A unified approach to interpreting model predictions,” Advances in Neural Information Processing Systems, pp. 4765-4774, (2017). However, the invention is not limited to this method, and any method may be used as long as a contribution rate with respect to prediction of each feature in a machine learning model can be calculated. Here, it is desirable that an initial value used for the contribution rate calculation be a reference schedule.

In a case where there is no conflict in each schedule even after replacing the respective features in the plan feature tables 1023 obtained from each of the target schedule and the reference schedule, the contribution rate calculation unit 1043 may directly calculate the contribution rate (that is, the influence degree) by a method for calculating a Shapley value described in Lundberg, Scott M., and Su-In Lee, “A unified approach to interpreting model predictions,” Advances in Neural Information Processing Systems, pp. 4765-4774, (2017) in step S508 without creating the machine learning model 1021 in step S507.

The above-described machine learning loop processing (steps S506 to S508) is repeatedly executed for all of the plurality of plan feature tables 1023 obtained by the feature conversion process in step S505 (step S509), and the process proceeds to step S510 if the processing is completed for all the plan feature tables 1023.

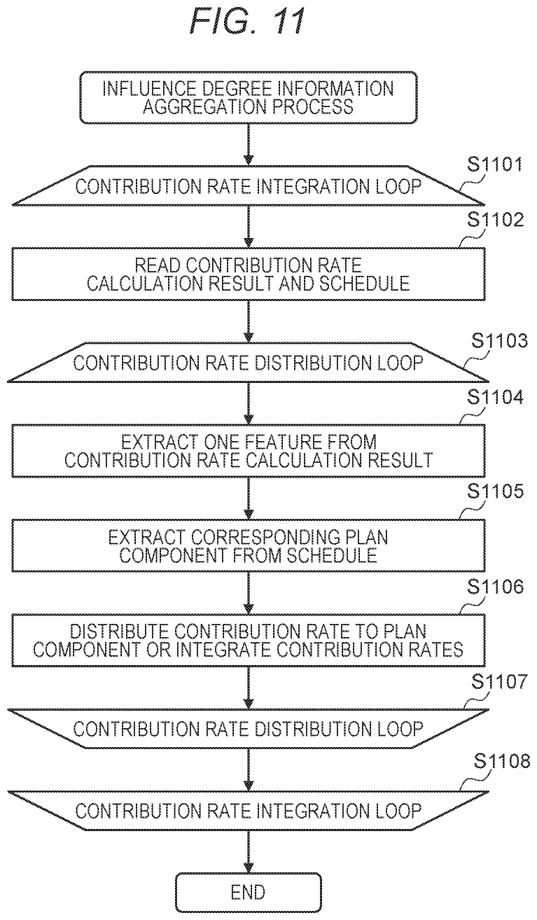

In step S510, the influence degree calculation unit 1044 executes an influence degree information aggregation process of distributing and integrating the contribution rate obtained in step S508 in the above loop processing and calculating an influence degree of a target schedule component on the KPI value. A detailed processing procedure of the influence degree information aggregation process will be described later with reference to FIG. 11.

Next, the influence degree calculation unit 1044 creates the influence degree calculation result 1025 by aggregating the respective influence degrees calculated in the process of step S510, and the KPI values and target schedule used to calculate the respective influence degrees, and stores the created influence degree calculation result 1025 in the storage apparatus 1001 (step S511).

Finally, the screen output unit 1050 generates the information for screen display based on the influence degree calculation result 1025 created in step S511, and transmits the information for screen display to the output apparatus 1004. As a result, the output apparatus 1004 displays the output screen based on the influence degree calculation result 1025 (step S512). A specific example of the output screen is illustrated in FIG. 14 to be described later.

FIG. 6 is a view illustrating an example of the feature conversion rule 1022. The feature conversion rule 1022 illustrated in FIG. 6 is a specific example of the feature conversion rule 1022 described in step S504 of FIG. 5.

In a case where a schedule is directly into a feature that can be applied to machine learning, it is common to adopt a method of performing conversion into a dummy variable as described in Christian D. Hubbs, Can Li, Nikolaos V. Sahinidis, Ignacio E. Grossmann, John M. Wassick, “A deep reinforcement learning approach for chemical production scheduling,” Computers and Chemical Engineering, 106982, vol. 141, (2020). However, such a conversion into the dummy variable results in a high-dimensional and sparse data structure, which leads to a problem that handling is difficult. Therefore, a feature is obtained by compression and conversion of a schedule using one or more methods in the present embodiment. A compression method may utilize some column information of the schedule or may be randomly determined.

In the feature conversion rule 1022 illustrated in FIG. 6, a feature conversion rule number 61, a schedule column 62, which is column information of the schedule 1014 to be utilized for compression, and a compression condition 63 thereof are described. In FIG. 6, as an example of a personnel assignment plan, compressing column information of “date” in the schedule “per date” is described in a rule number “1”, and compressing column information of “employee number” in the schedule “per number” is described in a rule number “2”. In this description, the compression condition 63 is described based on a natural language for readability, but the compression condition 63 is eventually converted into a format of a program or a mathematical formula suitable for the feature conversion unit 1041.

FIG. 7 is a flowchart illustrating an example of the processing procedure of the feature conversion process. The feature conversion process illustrated in FIG. 7 corresponds to the process of step S505 in FIG. 5, and is executed by the feature conversion unit 1041.

According to FIG. 7, the feature conversion unit 1041 receives inputs of the target schedule generated in step S501, the historical schedule obtained in the past, and the KPI values (KPI data 1015) of the target schedule and the historical schedule, and starts the following feature conversion loop processing (step S701).

In the feature conversion loop processing, the feature conversion unit 1041 first determines whether to apply the feature conversion rule 1022 to feature conversion based on a designation by the user in step S503 of FIG. 5 (step S702). If the feature conversion rule 1022 is applied (YES in step S702), the feature conversion unit 1041 reads the feature conversion rule 1022 created in step S504 of FIG. 5, then proceeds to step S703, selects one rule from the read feature conversion rule 1022, and proceeds to step S705. Note that the rules that have not been read in step S703 are sequentially selected in the feature conversion loop processing from the next time onward.

On the other hand, if it has not been designated to apply the feature conversion rule 1022 to the conversion of the feature (NO in step S702), the feature conversion unit 1041 performs random division or designates any column of the plan master information 31 in the target schedule and automatically creates a feature conversion rule (automatic rule) for information of the column (step S704), and proceeds to step S705. Specifically, in step S704, the feature conversion unit 1041 automatically designates the feature conversion rule for the information of the column per category in a case where the information of the designated column is a category or based on a range such as a maximum value and a minimum value in a case where the information of the designated column is a numerical value. It is possible to use basic clustering algorithm or conditional branching at the time of designating such a conversion rule.

As is clear from the evaluation index list 1013 illustrated in FIG. 2, the calculation process 24 is usually different per KPI (index), and thus, it is difficult to automatically divide a schedule into a format that can be calculated per KPI. However, the plan evaluation apparatus 1000 according to the present embodiment does not divide the schedule to calculate the KPI value by numerical calculation, but converts the schedule to be input to the machine learning model 1021. Thus, it suffices that the conversion into a simple numerical sequence as a feature can be performed even if the format that can be calculated per KPI is not provided. Therefore, there is no problem even if the schedule is divided according to the rule defined by the user, according to the automatically designated rule, or randomly by any method, and the influence degree on a KPI not allowing partial evaluation can be also calculated.

In step S705, the feature conversion unit 1041 determines whether to extract a difference of the schedule. The difference of the schedule is a difference between the target schedule and the reference schedule. There is a case where the comparison and model learning are facilitated by setting only the difference from the reference schedule as the target item 32 of the target schedule and evaluating this difference. Therefore, it is possible for the user to designate whether to extract the difference of the schedule in the present embodiment. The process proceeds to step S707 through step S706 if the difference of the schedule is to be extracted (YES in step S705), and directly proceeds to step S707 if the difference of the schedule is not to be extracted (NO in step S705).

In step S706, the feature conversion unit 1041 extracts only components (in the example of FIG. 3, one row corresponds to a “component”) in which the target item 32 is different from that of the reference schedule from the target schedule and the historical schedule other than the reference schedule, and stores these extracted components as new target schedule and historical schedule in the schedule 1014 of the storage apparatus 1001.

In step S707, the feature conversion unit 1041 divides the schedule (target schedule and historical schedule) according to the rule obtained in step S703 or step S704.

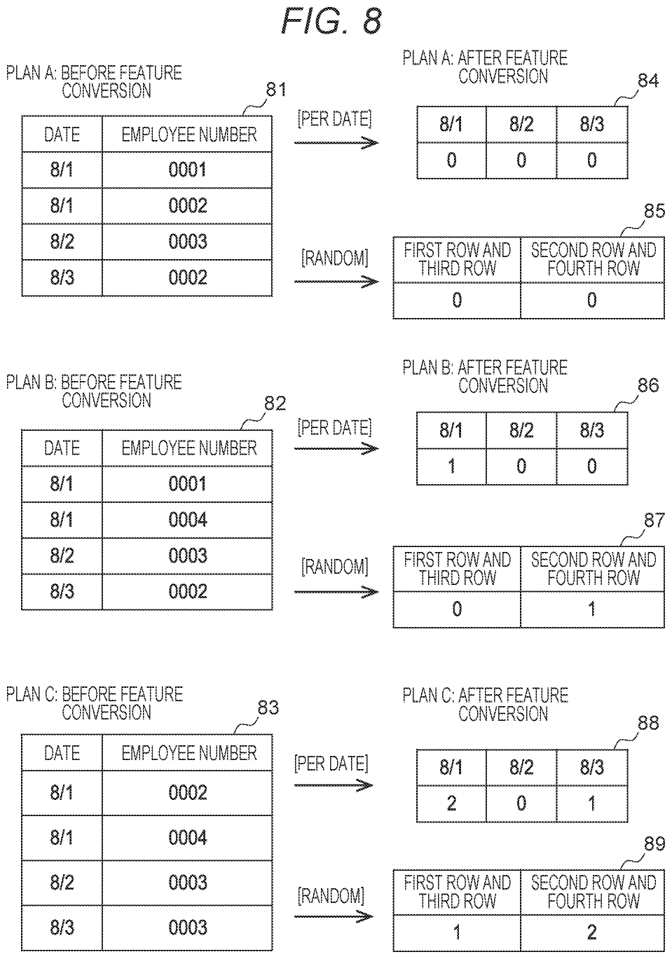

Next, the feature conversion unit 1041 performs compression and conversion on each of schedules divided in step S707 to convert a value of an item (the target item 32) into a “feature” using a category or a numerical value per plan (step S708). As a method for the compression and conversion, conversion into a feature (category or numerical value) unique to each combination of schedules may be performed, or conversion into a numerical value may be performed using an existing distance scale such as a cosine distance. A specific example of the compression and conversion will be described later with reference to FIG. 8.

Next, the feature conversion unit 1041 combines the feature per plan that has been obtained by the compression and conversion in step S708 and a corresponding KPI value (the value 43 of the KPI data 1015) to create the plan feature table 1023, and stores the plan feature table 1023 in the storage apparatus 1001 (step S709). Although a specific example will be described later with reference to FIG. 9, the component of each feature and the target item 32 before the conversion in step S708 are associated in the plan feature table 1023 such that a correspondence relationship therebetween can be confirmed later.

Then, the feature conversion unit 1041 repeats the processes of steps S702 to S709 until reaching a predetermined repeat upper limit (step S710). Note that the repeat upper limit may be designated based on the number of the feature conversion rules 1022 designated by the user, or time or the number of times of conversion (number of loops) may be explicitly designated in advance. However, when the feature conversion rule 1022 has been newly described by the user (see step S504 in FIG. 5), it is preferable to preferentially execute feature conversion according to this feature conversion rule 1022.

As described above, the feature conversion loop processing is performed so that a plurality of times of compression and conversion are performed in the feature conversion process. Thus, the plan evaluation apparatus 1000 can analyze the schedule from various viewpoints, and the reliability of the influence degree to be calculated can also be enhanced.

FIG. 8 is a view for describing an image of the compression and conversion in the feature conversion process. The image of the compression and conversion illustrated in FIG. 8 is obtained by visualizing the process of step S708 in FIG. 7 using a concrete example. Specifically, a reference schedule 81 before being compressed and converted into features and reference schedules 84 and 85 after being compressed and converted into features are illustrated for a plan A which is a reference schedule. A target schedule 82 before being compressed and converted into features and target schedules 86 and 87 after being compressed and converted into features are illustrated for a plan B which is a target schedule. A historical schedule 83 before being compressed and converted into features and historical schedules 88 and 89 after being compressed and converted into features are illustrated for a plan C which is one of a plurality of historical schedules.

In the example of FIG. 8, “per date” and “random” are adopted as schedule division rules. The compression and conversion according to each of the division rules will be specifically described hereinafter.

In the compression and conversion according to the division rule of “per date”, numerical values are assigned to columns per day in the reference schedule 84, the target schedule 86, and the historical schedule 88 after being compressed and converted into features. These numerical values are obtained by compressing and converting employee numbers in the original schedule. Specifically, for example, a compression rule is adopted in which a combination appearing in the original reference schedule 81 of the plan A is set to “0”, and a different combination not appearing in the reference schedule 81 is set to another numerical value such as “1”.

Since the above compression rule is adopted, all values of the respective dates are naturally converted to “0” in the reference schedule 84 after the compression and conversion of the plan A.

Further, in the target schedule 86 after the compression and conversion of the plan B, employee numbers of “8/1” in the target schedule 82 form different combinations from those of the reference schedule 81 and, thus, a value of the date is converted to “1”. Further, employee numbers of “8/2” and “8/3” in the target schedule 82 form the same combinations as those of the reference schedule 81 and, thus, values of the dates are converted to “0”.

In the case of the plan C, an employee number of “8/2” in the historical schedule 83 forms the same combination as that of the reference schedule 81, and employee numbers of “8/1” and “8/3” in the historical schedule 83 form different combinations from those of the reference schedule 81. Here, when the compression and conversion is performed in the same manner as in the above-described plan B, in the historical schedule 88 after the compression and conversion of the plan C, a value of “8/2” is converted to “0”, and values of “8/1” and “8/3” are converted to “1”.

In the case of FIG. 8, however, as an additional compression rule, a rule of converting a value into “2” is adopted, in the compression and conversion of the historical schedule (plan C), in a case where a combination appearing in the original historical schedule is different from those of both the reference schedule (plan A) and the target schedule (plan B). At this time, the combinations with employee numbers (“0002” and “0004”) of “8/1” in the historical schedule 83 is different from both the combinations with employee numbers (“0001” and “0002”) of “8/1” in the reference schedule 81 and the combinations with employee numbers (“0001” and “0004”) of “8/1” in the target schedule 82. Thus, the value of “8/1” is converted to “2” in the historical schedule 88 after the compression and conversion of the plan C.

Next, in the compression and conversion according to the division rule of “random”, each schedule is divided per row not by a clear rule, such as a value per column (for example, date), but by a combination of random columns, and a compression rule similar to the division rule of “per date” is applied for divided items. Thereby, a combination of employee numbers is converted into a feature based on a numerical value.

Specifically, for example, in a case where “first row and third row” are selected as the combination of columns in the division rule of “random”, a combination of employee numbers of the “first row and third row” in the historical schedule 83 (plan C) before the compression and conversion is “0001” and “0003”. Therefore, the feature conversion unit 1041 can determine a feature (value) of a corresponding item in the historical schedule 89 by comparing this combination of employee numbers with a similar combination of employee numbers in each of the reference schedule 81 (plan A) and the target schedule 82 (plan B).

Note that the above-described compression and conversion method is merely an example, and the compression and conversion of the feature in the present embodiment is not limited thereto. For example, the above-described compression rule uses a combination in the reference schedule 81 (plan A) as a baseline; however, the baseline is not limited to the reference schedule.

FIG. 9 is a view illustrating an example of the plan feature table 1023. The plan feature table 1023 illustrated in FIG. 9 is a specific example of the plan feature table 1023 created by the feature conversion unit 1041 and stored in the storage apparatus 1001 in step S709 of FIG. 7, and includes a plan number 91 (information for the association between the component of the feature with the target item 32 before the compression and conversion described in step S709), which is a source of each feature, a feature 92 serving as an input variable of the machine learning model 1021, and the KPI 93 serving as an objective variable of the machine learning model 1021.

The plan feature table 1023 configured as described above is incorporated into the machine learning model 1021 in step S507 of FIG. 5 described above. In the next step S508, the contribution rate (a contribution rate 103 in the contribution rate calculation result 1024 of FIG. 10) of the feature with respect to the model is calculated.

FIG. 10 is a view illustrating an example of the contribution rate calculation result 1024. The contribution rate calculation result 1024 illustrated in FIG. 10 is information indicating a calculation result of a contribution rate of each feature with respect to the machine learning model 1021 calculated by the contribution rate calculation unit 1043 in step S508 of FIG. 5.

As illustrated in FIG. 10, the contribution rate calculation result 1024 includes a feature name 101, which is a column name of each feature, a value 102 of the feature, and the contribution rate 103 of the feature with respect to the machine learning model 1021. The contribution rate calculation result 1024 is created for each of one or more machine learning models 1021. After contribution rates for respective plan features are obtained in the one or more machine learning models 1021, the influence degree information aggregation process (step S510 in FIG. 5) illustrated in FIG. 11 is executed.

FIG. 11 is a flowchart illustrating an example of the processing procedure of the influence degree information aggregation process. The influence degree information aggregation process illustrated in FIG. 11 corresponds to the process of step S510 in FIG. 5, and is a process in which the influence degree calculation unit 1044 distributes the contribution rates calculated in step S509 to components of a target schedule and integrates the contribution rates to calculate influence degrees of influence, on KPI values, of the components of the target schedule.

According to FIG. 11, the influence degree calculation unit 1044 starts the following contribution rate integration loop processing (step S1101). At this time, the machine learning loop of the influence degree calculation process (steps S506 to S509 in FIG. 5) has ended, and thus, the contribution rate calculation result 1024 has already been calculated per target schedule.

In the contribution rate integration loop processing, the influence degree calculation unit 1044 first extracts a set of the contribution rate calculation result 1024 and a target schedule (the schedule 1014) corresponding thereto (step S1102).

Next, the influence degree calculation unit 1044 starts contribution rate distribution loop processing of distributing a contribution rate to a plan component for each feature whose contribution rate is indicated in the contribution rate calculation result 1024 extracted in step S1102 (step S1103). The contribution rate is an influence degree with respect to prediction for each feature of a simple numerical sequence. However, the feature is a numerical value obtained by converting each plan component, and thus, it is difficult to obtain an influence degree of a plan component on a KPI only by the contribution rate. Therefore, the contribution rate in the machine learning model 1021 is applied to the schedule by executing the contribution rate distribution loop processing to distribute the contribution rate to the plan component in the present invention.

In the contribution rate distribution loop processing, the influence degree calculation unit 1044 selects one feature from the contribution rate calculation result 1024 extracted in step S1102 (step S1104). If the contribution rate calculation result 1024 in FIG. 10 is taken as an example, the influence degree calculation unit 1044 extracts one row in step S1104.

Next, the influence degree calculation unit 1044 extracts plan components before conversion of the feature selected in step S1104 from a corresponding schedule extracted in step S1102 (step S1105).

Next, the influence degree calculation unit 1044 distributes the contribution rate 103 of the row extracted from the contribution rate calculation result 1024 in step S1104 to the plan components extracted in step S1105 (step S1106). A method for this distribution is not particularly limited, and for example, there are a method of evenly allocating the contribution rate to each of the plan components and a method of allocating the value (contribution rate) as it is. Further, for example, an algorithm such as a machine learning model may be used to determine the distribution of the contribution rate.

Further, when a contribution rate in another machine learning model 1021 already exists in the plan component, the influence degree calculation unit 1044 integrates the existing contribution rate and the newly distributed contribution rate in step S1106. A method for this integration is not particularly limited, and any method such as simple addition, weighting, and multiplication may be adopted.

Then, the influence degree calculation unit 1044 repeats the contribution rate distribution loop processing (steps S1104 to S1106) as many as the number of types of features illustrated in the contribution rate calculation result 1024 extracted in step S1102 (step S1107).

Then, after the contribution rate distribution loop processing ends, the influence degree calculation unit 1044 repeats the contribution rate integration loop processing (steps S1102 to S1107) for all the contribution rate calculation results 1024 (step S1108), and then ends the influence degree information aggregation process.

FIG. 12 is a view illustrating an example of the influence degree calculation result 1025. The influence degree calculation result 1025 illustrated in FIG. 12 is a specific example of the influence degree calculation result 1025 created by the influence degree calculation unit 1044 and stored in the storage apparatus 1001 in step S511 of FIG. 5.

The influence degree calculation result 1025 is configured as matrix data (table data) similarly to the schedule 1014 illustrated in FIG. 3, and includes items of plan master information 1201 that is fixed in common to all schedules, a target item 1202 unique to each of the schedules, and a calculated influence degree 1203.

Since the influence degree calculation result 1025 is created in a format as illustrated in FIG. 12, the user (developer) can immediately find a component having a large influence degree on a KPI from among the enormous components of the schedules by referring to the influence degree calculation result 1025, and can promptly start examining a revision for improvement of the KPI.

Furthermore, the influence degree 1203 indicated in the influence degree calculation result 1025 is the influence degree obtained from the result of learning the relationship between the schedule 1014 and the KPI value (KPI data 1015) by the machine learning model 1021. Thus, the plan evaluation apparatus 1000 according to the present embodiment can extract not only a component that directly affects the KPI value but also a component that is likely to indirectly affect the KPI value, which is different from the technique of JP 2019-209796 A in which only a component that directly changes a KPI value can be extracted.

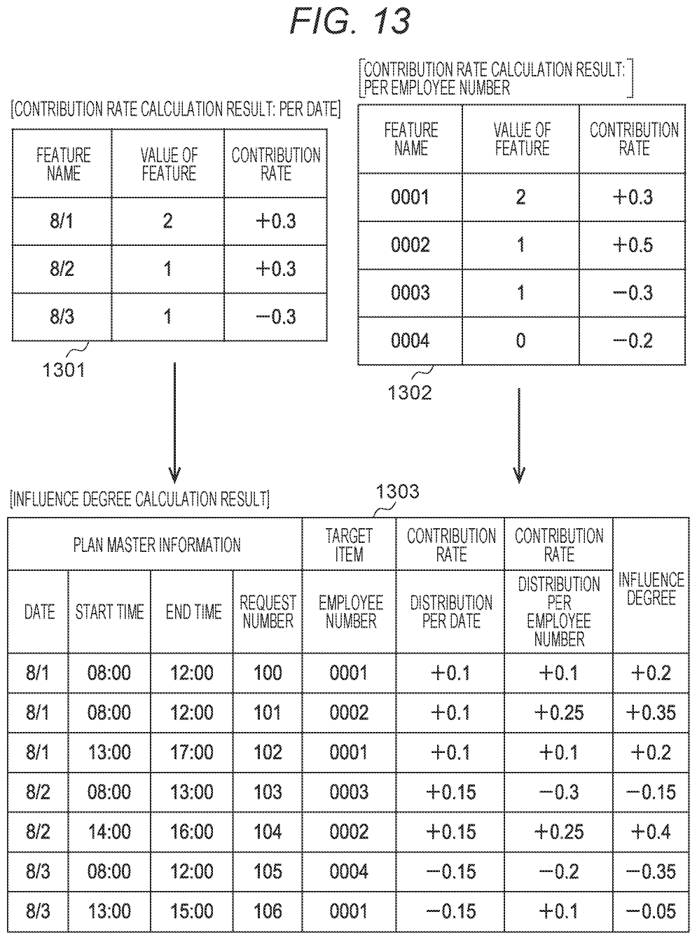

FIG. 13 is a view for describing an image of a process of distributing and integrating contribution rates. The image illustrated in FIG. 8 is obtained by visualizing the process of step S1106 in FIG. 11 using a concrete example.

FIG. 13 illustrates the image in which an influence degree calculation result 1303 is created, based on a contribution rate calculation result 1301 for a feature generated by compression and conversion according to a division rule of “per date” and a contribution rate calculation result 1302 for a feature generated by compression and conversion according to a division rule of “per number” of an employee number, by distributing contribution rates of the results to the respective plan components and integrates the contribution rates.

In the case of FIG. 13, “average allocation” is used as a method for the contribution rate distribution, and “simple addition” is used for the contribution rate integration. For example, when attention is paid to the first row of the plan component of the influence degree calculation result 1303, first, the date is “8/1”, a contribution rate of the feature “8/1” in the contribution rate calculation result 1301 is confirmed as “+0.3”, and “+0.1” obtained by distributing this contribution rate is described as a contribution rate of “distribution per date”. Here, the value obtained by distributing the contribution rate “+0.3” is “+0.1” because there are three components whose date is “8/1” in the influence degree calculation result 1303 (the first to third rows from the top) so that the contribution rate is divided by three according to the distribution method of the average allocation. In the first row of the plan component of the influence degree calculation result 1303, “+0.1” is described as a contribution rate of “distribution per employee number” as a result of similarly distributing a contribution rate of an employee number “0001”. In the first row of the plan component of the influence degree calculation result 1303, finally, the contribution rate “+0.1” of the date “8/1” and the contribution rate “+0.1” of the employee number “0001” are integrated (here, according to the simple addition), whereby “+0.2” is calculated as an influence degree of the integration result.

FIG. 14 is a view illustrating an example of the output screen based on the influence degree calculation result 1025. An output screen 1400 illustrated in FIG. 14 is a specific example of the output screen displayed on the output apparatus 1004 in step S512 of FIG. 5, and displays a content of the influence degree calculation result 1025 created in step S511 of FIG. 5 in a shaped form that is easy for the user to understand.

The output screen 1400 of FIG. 14 is an output in a format of a gantry chart in a personnel assignment plan, and includes an employee number 1401, a date 1402 of each request, a plan component 1403 having a small influence degree, and a plan component 1404 having a large influence degree. In this example, plan component values described in the plan components 1403 and 1404 mean request numbers in the personnel assignment plan (for example, “request numbers” in the plan master information 1201 of FIG. 12).

On the output screen 1400, whether to classify each plan component (request number in the this example) into the plan component 1403 having a small influence degree or the plan component 1404 having a large influence degree may be determined by any method based on a value of an influence degree in the influence degree calculation result 1025. For example, request numbers indicating a predetermined number of influence degrees from the top may be classified into the plan component 1404 having a large influence degree, or a request number indicating an influence degree exceeding a predetermined threshold may be classified into the plan component 1404 having a large influence degree.

In FIG. 14, a request number “105” and a request number “112” are highlighted as the plan components 1404 having a high influence degree, so that the user can immediately identify an important part from the output screen 1400. Note that a display method is not limited, and any method may be used, for example, a method of omitting a display of the plan component 1403 having a small influence degree, a method of displaying the magnitude of an influence degree with color gradation based on a value of the influence degree in the influence degree calculation result 1025, or the like.

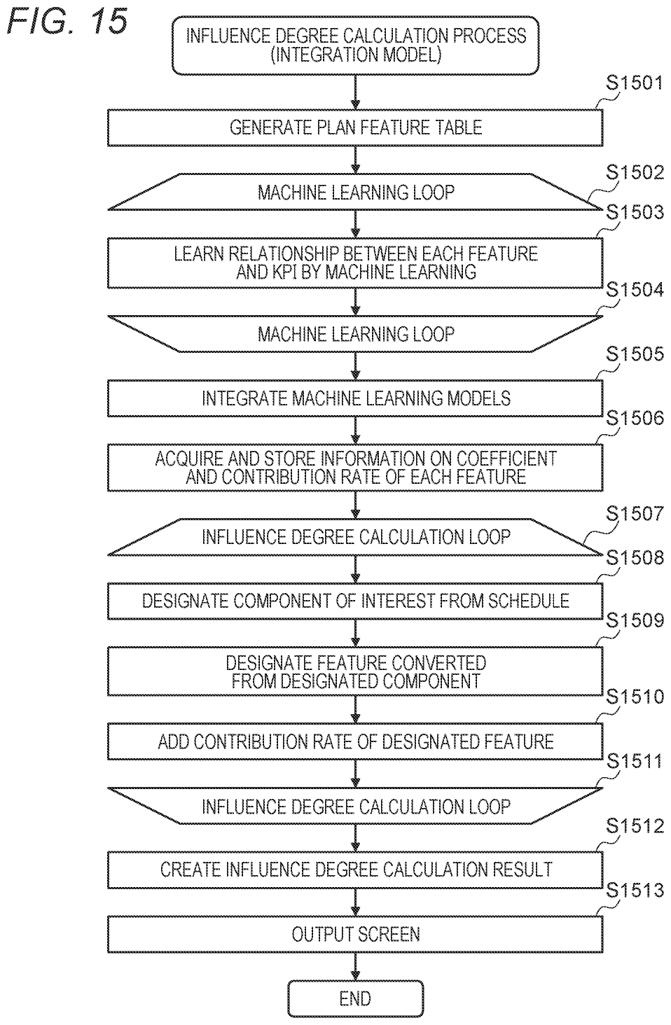

In the above-described influence degree calculation process of FIG. 5, the influence degree per component (plan component) of the schedule is calculated by calculating the contribution rates for respective machine learning models 1021, and then, distributing and integrating the contribution rates. However, as another processing procedure of the influence degree calculation process, the plan evaluation apparatus 1000 according to the present embodiment can also calculate the contribution rates after integrating the machine learning models 1021 first and calculate the influence degree per plan component. The influence degree calculation process by such a processing procedure is called an influence degree calculation process by an integration model, and an example of the processing procedure is illustrated in FIG. 15 hereinafter.

FIG. 15 is a flowchart illustrating an example of the processing procedure of the influence degree calculation process by the integration model. Note that detailed descriptions are sometimes omitted regarding similar processes as those of the influence degree calculation process illustrated in FIG. 5 among the respective processes illustrated in FIG. 15.

In FIG. 15, first, the same processes as those in steps S501 to S505 of FIG. 5 are performed, and eventually, the feature conversion unit 1041 generates the plan feature tables 1023 (step S1501).

Next, the influence degree evaluation processing unit 1040 selects one from the plurality of plan feature tables 1023 obtained in step S1501 and starts machine learning loop processing (step S1502).

In the machine learning loop processing, first, the model learning unit 1042 first performs machine learning with the plan feature table 1023 as an input and the KPI data 1015 (which may be read as the KPI 93 of the plan feature table 1023) corresponding to the plan feature table 1023 as an output in the same manner as in step S507 in FIG. 5, thereby creating the machine learning model 1021 that has learned a relationship between each schedule and the KPI data 1015 (step S1503).

Then, the machine learning loop processing of FIG. 15 is different from the machine learning loop processing of FIG. 5 in that the process of step S1503 is repeatedly executed for all of the plurality of plan feature tables 1023 (step S1504) without performing the process corresponding to step S508 of FIG. 5, and the process proceeds to step S1505 when the machine learning models 1021 are created for all of the plan feature tables 1023.

In step S1505, the model learning unit 1042 integrates the plurality of machine learning models 1021 created by the machine learning loop processing. The integrated model is referred to as the integration model. As an integration method of the integration model in step S1505, an existing integration method may be adopted, and for example, a weighted averaging of outputs, a stacking method of stacking the machine learning models 1021, or the like can be used.

Next, the contribution rate calculation unit 1043 calculates a contribution rate of each feature in the integration model integrated in step S1505, and stores information indicating the calculation result (contribution rate calculation result 1024) in the storage apparatus 1001 (step S1506). As a method for calculating the contribution rate, an existing technique may be used in the same manner as described in step S508 of FIG. 5.

Next, the influence degree calculation unit 1044 starts influence degree calculation loop processing per plan component of a target schedule (step S1507). When attention is paid to a certain plan component of the target schedule, the compression and conversion into one feature is performed for one machine learning model 1021 in the influence degree calculation process of FIG. 5, but one integration model is subjected to conversion into a plurality of features since the plurality of machine learning models 1021 are integrated into the integration model in the influence degree calculation process of FIG. 15.

In the influence degree calculation loop processing, the influence degree calculation unit 1044 first selects one plan component set as a target of the calculation of an influence degree from the target schedule (step S1508).

Next, the influence degree calculation unit 1044 selects, from the integration model, features in which the plan component selected in step S1508 is included as a conversion source (step S1509).

Next, the influence degree calculation unit 1044 calculates a total value of contribution rates of the features selected in step S1509 (step S1510). The total value of the contribution rates calculated in step S1510 is adopted as an approximation of the influence degree of the target plan component. Therefore, as the machine learning models 1021 are generated and integrated from more plan feature tables 1023, more features can be compressed and converted for the target plan component, which leads to calculation of the influence degree of the feature. That is, as the machine learning models 1021 are generated and integrated from more plan feature tables 1023, pieces of information serving as sources of influence degrees increase, which leads to improvement of the reliability of the influence degree (total value of contribution rates) calculated in step S1510.

The above-described influence degree calculation loop processing (steps S1507 to S1510) is repeatedly executed for all the plan components included in the target schedule (step S1511), and the process proceeds to step S1512 when the influence degrees are calculated for all the plan components.

In step S1512, the influence degree calculation unit 1044 creates the influence degree calculation result 1025 by aggregating the respective influence degrees of the plan components calculated in the influence degree calculation loop processing, and KPI values and the target schedule used to calculate the respective influence degrees, and stores the created influence degree calculation result 1025 in the storage apparatus 1001.

Finally, the screen output unit 1050 generates information for screen display based on the influence degree calculation result 1025 created in step S1512, and transmits the information for screen display to the output apparatus 1004. As a result, the output apparatus 1004 displays an output screen based on the influence degree calculation result 1025 (step S1513).

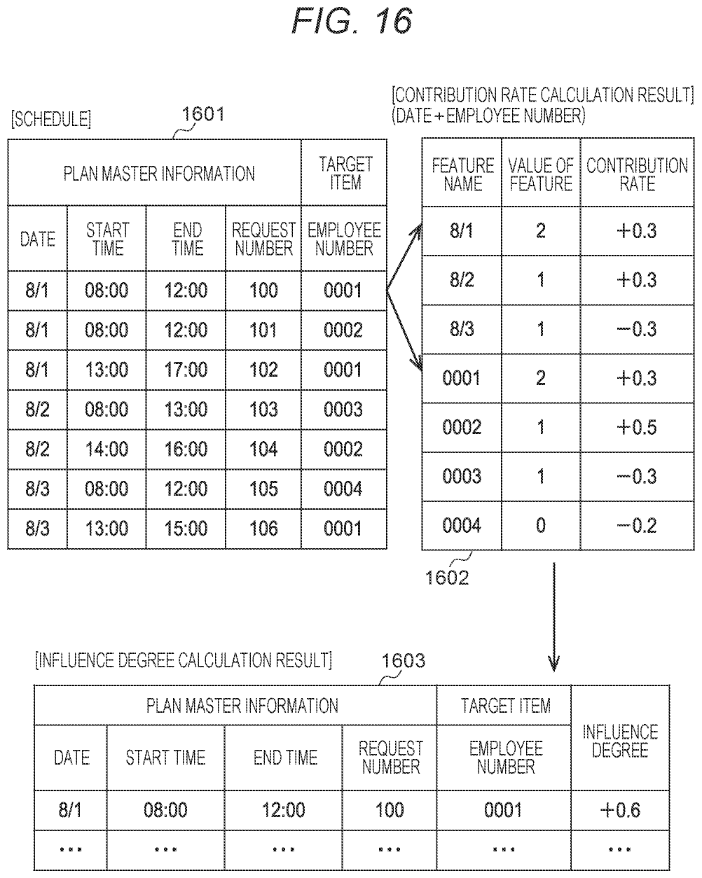

FIG. 16 is a view for describing an image of a process of calculating an influence degree in the influence degree calculation process by the integration model. The image illustrated in FIG. 16 is obtained by visualizing the process of step S1510 in FIG. 15 using a concrete example.

FIG. 16 illustrates: a target schedule 1601 as an example of the target schedule used as the target of calculation of the influence degree in the influence degree calculation process of FIG. 15; a contribution rate calculation result 1602 as an example of the contribution rate calculation result 1024 of the integration model calculated in step S1506 of the same process; and an influence degree calculation result 1603 as an example of the influence degree calculation result 1025 created in step S1512 of the same process.

An example of the creation of the influence degree calculation result 1603 in FIG. 16 will be described with reference to specific values. When attention is paid to the plan component in the first row of the target schedule 1601, the date is “8/1” and an employee number is “0001”, and thus, it can be seen in the contribution rate calculation result 1602 that features of “8/1” and “0001” have been obtained by conversion. Contribution rates of these features are both “+0.3”, and a result obtained by simply adding these contribution rates is output to the influence degree calculation result 1603 as the influence degree of the plan component of interest in this example. That is, in the influence degree calculation result 1603, the influence degree of the feature of the employee number “0001” of the date “8/1” is calculated as “+0.6”.

As described above, according to the plan evaluation apparatus 1000 of the first embodiment, the method of calculating the influence degree of the feature in the machine learning model 1021 is expanded to the evaluation of the schedule (evaluation per plan component) and the evaluation results thereof are created and output. Thus, it is possible to extract, from the schedule, the component having a large influence degree directly or indirectly on not only the KPI allowing partial evaluation but also the KPI not allowing partial evaluation.

Further, the method of interpreting and comparing the evaluation results using the plan evaluation apparatus 1000 when one target schedule is set as the target of calculation of the influence degree has been described in the above first embodiment. However, there is a case where a plurality of plans (target schedules) are made at a time, for example, when the plan generation unit 1031 is an algorithm that performs iterative calculation.

The plan evaluation apparatus 1000 according to the present embodiment can be applied even in the case where the plurality of target schedules exist as described above. Specifically, the plan evaluation apparatus 1000 can evaluate and visualize a change of a plan component having a large influence degree or the like by determining one common reference schedule and calculating influence degrees of the respective target schedules. As a result, the user (developer) can have an insight, for example, that a plan part having a large influence degree had been obtained in the middle of the iterative calculation, but has been replaced with another item in the final output.

Further, the influence degree on the single KPI is calculated in the above description of the present embodiment, but the plan evaluation apparatus 1000 can calculate an influence degree of each plan component on a plurality of KPIs by repeating this process. Then, the plan evaluation apparatus 1000 can calculate the influence degree of each plan component on the entire KPI through addition that utilizes weights of the KPIs determined by any method.

Further, an operation of partially replacing a plan component of a target schedule and calculating an influence degree in the replaced schedule can also be executed by utilizing the data input unit 1060 in the plan evaluation apparatus 1000 according to the present embodiment. When such an operation is performed, it is possible to interactively or automatically perform evaluation when the schedule is revised, which can contribute to reduction of development man-hours.

### (2) Second Embodiment

A second embodiment of the present invention is a development of the first embodiment. In the first embodiment described above, the influence degrees of the plan components are calculated based on the machine learning model 1021, and thus, the plan components include both of the plan component that directly changes the KPI and the plan component that indirectly changes the KPI. That is, no attempt has been made to extract which part of the plan components has an indirect influence relationship in the first embodiment. Therefore, in the second embodiment, an indirect influence relationship between plan components (hereinafter referred to as indirect influence relationship) is further extracted from the influence degrees obtained in the first embodiment.

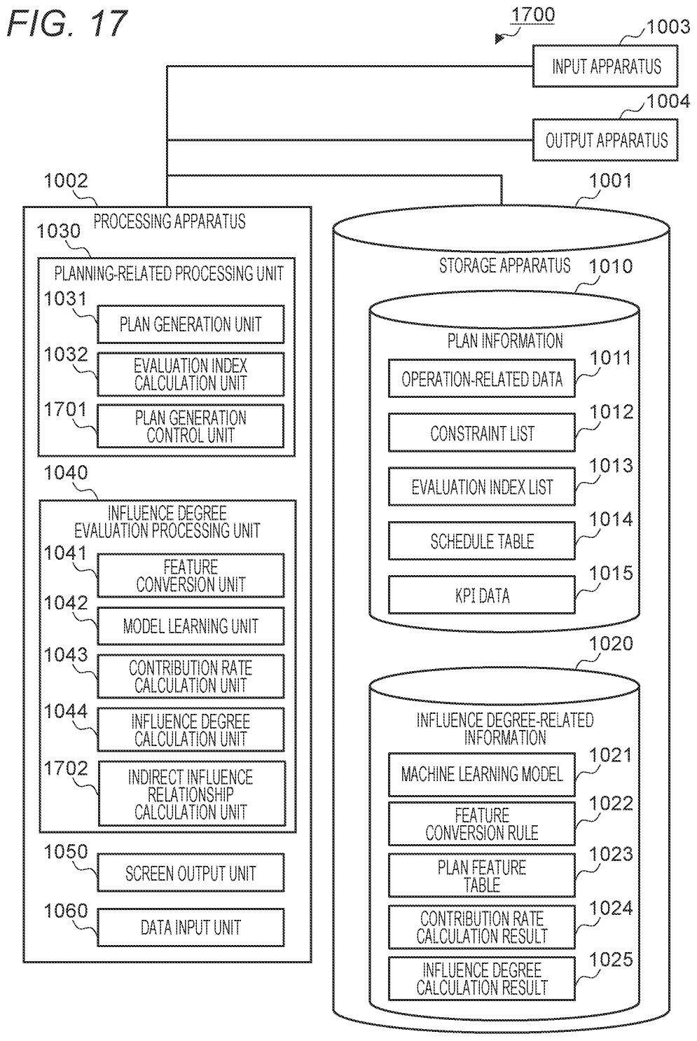

FIG. 17 is a block diagram illustrating a configuration example of a plan evaluation apparatus 1700 according to the second embodiment of the present invention. As is clear from a comparison with FIG. 1, the plan evaluation apparatus 1700 according to the second embodiment has expanded configurations of the plan evaluation apparatus 1000 according to the first embodiment. Specifically, the plan evaluation apparatus 1700 includes a plan generation control unit 1701 in the planning-related processing unit 1030 and an indirect influence relationship calculation unit 1702 in the influence degree evaluation processing unit 1040 as added points with respect to the plan evaluation apparatus 1000 A specific method of utilizing these added configurations will be described later.

In the second embodiment, a first approach that is effective when there is randomness in plan generation, and a second approach that is effective when it is difficult to generate a plan a plurality of times can be adopted in order to extract an indirect influence relationship.

First, a process of extracting an indirect influence relationship according to the first approach will be described.

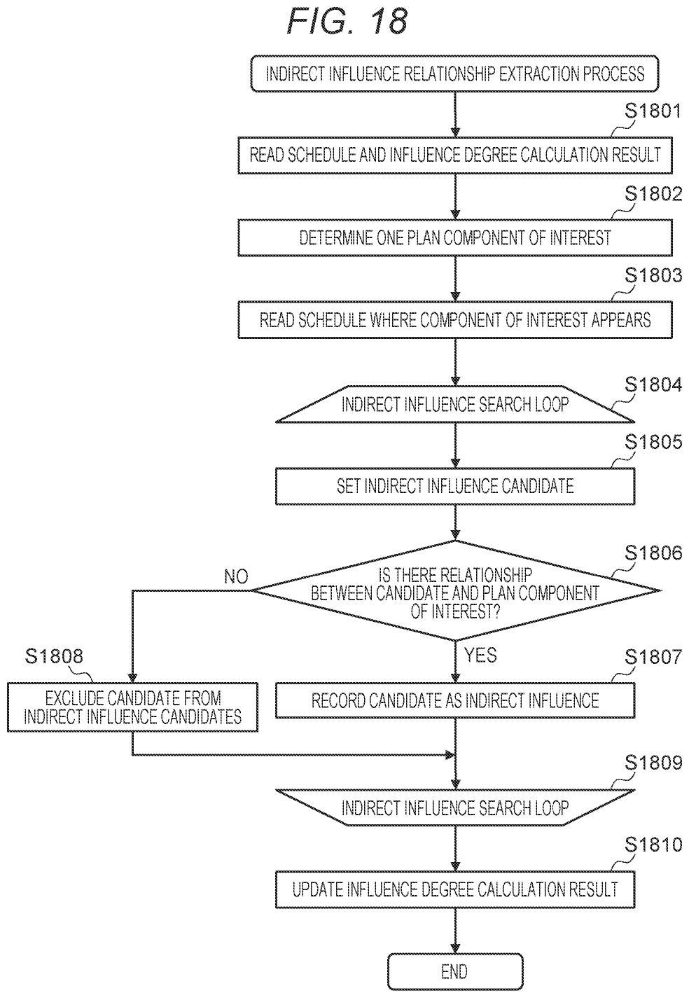

FIG. 18 is a flowchart illustrating an example of a processing procedure of a first indirect influence relationship extraction process. The first indirect influence relationship extraction process is a process of extracting an indirect influence relationship using a historical schedule that has already been made based on the first approach, and is executed by the indirect influence relationship calculation unit 1702 after the end of the influence degree calculation process in FIG. 5 or FIG. 15 described in the first embodiment.

According to FIG. 18, first, the indirect influence relationship calculation unit 1702 reads the influence degree calculation result 1025 of a target schedule calculated by the influence degree calculation process and historical schedules obtained by the process of the plan generation unit 1031 (step S1801).

Next, the indirect influence relationship calculation unit 1702 determines one plan component of interest from the influence degree calculation result 1025 read in step S1801 (step S1802). The following processes are performed to extract an indirect influence relationship for this plan component of interest. Therefore, it is preferable that the plan component selected in step S1802 be a plan component for which it is desired to perform detailed analysis, such as one having a large influence degree.

Next, the indirect influence relationship calculation unit 1702 extracts, from the historical schedules read in step S1801, a historical schedule in which the plan component of interest determined in step S1802 appears (step S1803).

Next, the indirect influence relationship calculation unit 1702 starts loop processing for searching for an indirect influence relationship (step S1804).

In the indirect influence search loop processing, the indirect influence relationship calculation unit 1702 first sets one “indirect influence candidate”, which is a candidate for a plan component having an indirect influence relationship with the plan component of interest, from the target schedule (step S1805). Although any method may be used as a method for setting an indirect influence candidate, a plan component that is important in the sense of indirect influence is highly likely to be included in a part having a large influence degree according to the machine learning model 1021. Thus, a method of setting indirect influence candidates in order from a plan component having a larger influence degree other than the plan component of interest and performing the following search is commonly used.

Next, the indirect influence relationship calculation unit 1702 extracts a historical schedule in which the indirect influence candidate set in step S1805 appears from the historical schedules read in step S1801, and determines whether there is a relationship with the historical schedule including the plan component of interest extracted in step S1803 (step S1806). The most common method for determining the relationship is a method of comparing each number of the respective historical schedules, but the relationship may be determined using a certain quantitative index such as a correlation.

In step S1806, if there is a relationship between the two schedules, for example, if the number of historical schedules including the indirect influence candidate is equal to the number of historical schedules including the plan component of interest (YES in step S1806), the indirect influence relationship calculation unit 1702 determines that there is an indirect influence relationship and records the indirect influence candidate set in step S1805 in a predetermined recording destination (step S1807). That is, the indirect influence candidate recorded in step S1807 corresponds to a plan component (indirect influence component) that indirectly affects a change of a KPI in relation to the plan component of interest.

On the other hand, in step S1806, if there is no relationship between the two schedules, for example, if the number of historical schedules including the indirect influence candidate is not equal to the number of historical schedules including the plan component of interest (NO in step S1806), the indirect influence relationship calculation unit 1702 determines that there is no indirect influence relationship and excludes the plan component set in step S1805 from the indirect influence candidates (step S1808).

Then, after step S1807 or step S1808, the indirect influence relationship calculation unit 1702 repeatedly executes the loop processing from steps S1804 to S1807 (or S1808) until reaching a predetermined search upper limit related to the search for the indirect influence candidate (step S1809), and proceeds to step S1810 after the end of the loop processing. Note that the predetermined search upper limit related to the search for the indirect influence candidate may be determined, for example, using a calculation time or a threshold of an influence degree of a candidate component.

In step S1810, the influence degree calculation result 1025 read in step S1801 is updated by adding a search result (specifically, the indirect influence candidate recorded in step S1807) of the indirect influence relationship by the above processing thereto, thereby ending the indirect influence relationship extraction process.

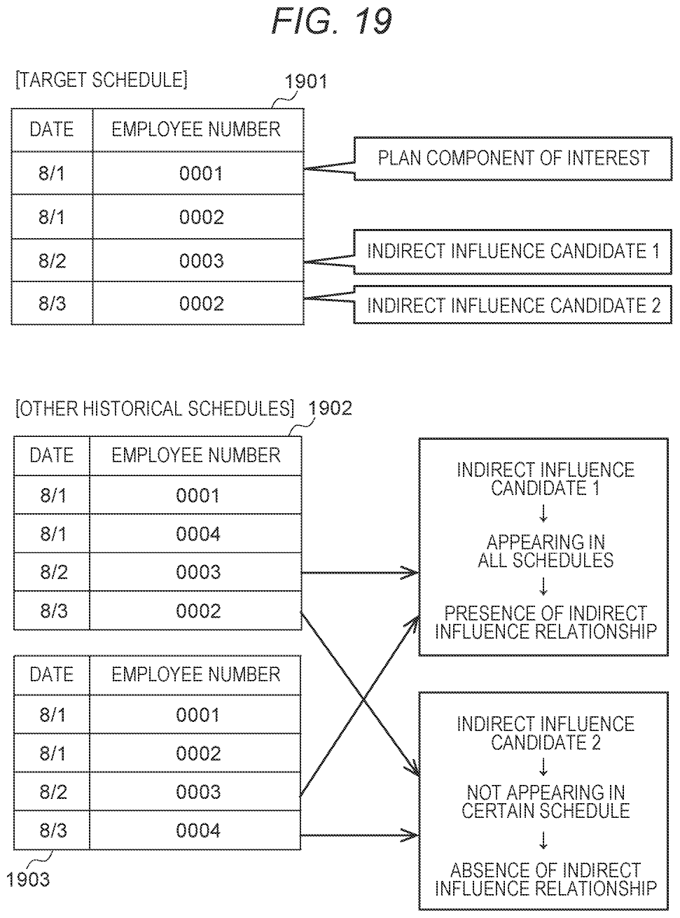

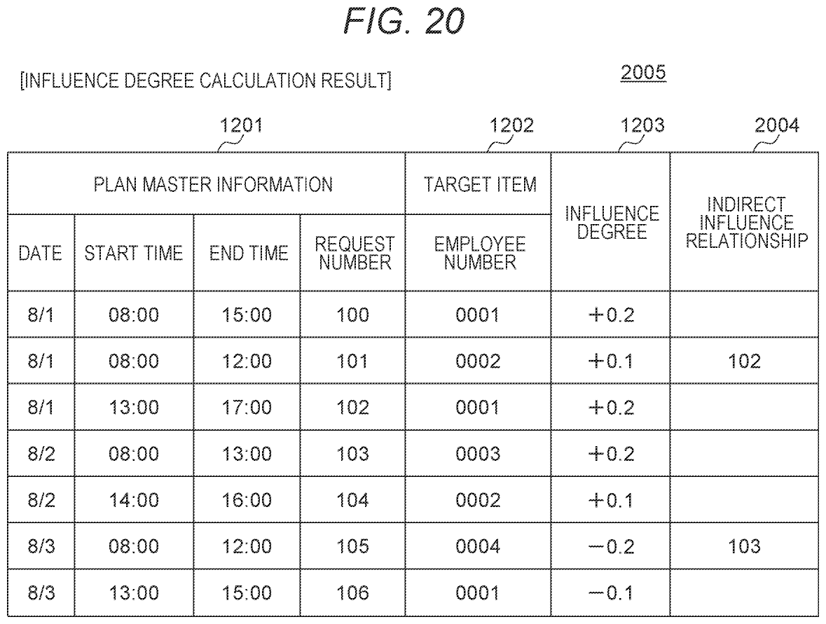

FIG. 19 is a view for describing an image of a process of searching for an indirect influence relationship. The image illustrated in FIG. 19 is obtained by visualizing an outline of the processing from steps S1801 to S1808 in FIG. 18 using a concrete example.

FIG. 19 illustrates a target schedule 1901 and other historical schedules 1902 and 1903 as examples of historical schedules in which the presence or absence of an indirect influence relationship is determined for a plan component of interest of the target schedule 1901.

In the target schedule 1901, a row with the date “8/2” and a row with the date “8/3” are set as indirect influence candidates paying attention to a plan component in the first row. Here, when the other historical schedules 1902 and 1903 are confirmed, an indirect influence candidate 1 illustrated in FIG. 19 appears in both of the historical schedules 1902 and 1903, and thus, the indirect influence candidate 1 is determined to have an indirect influence relationship and is recorded. On the other hand, an indirect influence candidate 2 illustrated in FIG. 19 appears in the historical schedule 1902 but does not appear in the historical schedule 1903, and thus, the indirect influence candidate 2 is determined not to have an indirect influence relationship, and is excluded from the indirect influence candidates.

FIG. 20 is a view illustrating an example of the influence degree calculation result 1025 including the indirect influence relationship. An influence degree calculation result 2000 illustrated in FIG. 20 is a specific example of the influence degree calculation result 1025 after an indirect influence relationship determination result is updated by the indirect influence relationship extraction process illustrated in FIG. 18.

The influence degree calculation result 2000 is configured as matrix data (table data) similarly to the schedule 1014 illustrated in FIG. 3 or the influence degree calculation result 1025 illustrated in FIG. 12, and includes items of plan master information 1201 that is fixed in common to all schedules, a target item 1202 unique to each of the schedules, and a calculated influence degree 1203. Furthermore, the influence degree calculation result 2000 has an indirect influence relationship 2004 indicating a plan component having an indirect influence relationship as a new item added to the influence degree calculation result 1025 in FIG. 12.

In the example of FIG. 20, a request number is described in the indirect influence relationship 2004. Specifically, for example, it is illustrated that a plan component of the second row has an indirect influence relationship with respect to a plan component (request number “102”) of the third row since a request number “102” is described in the indirect influence relationship 2004. Note that a description format of the indirect influence relationship 2004 is not limited to the format that refers to the request number as described above, and any format that can designate a plan component may be used, for example, by designating another column or row number or the like.

Next, a process of extracting an indirect influence relationship according to the second approach will be described.

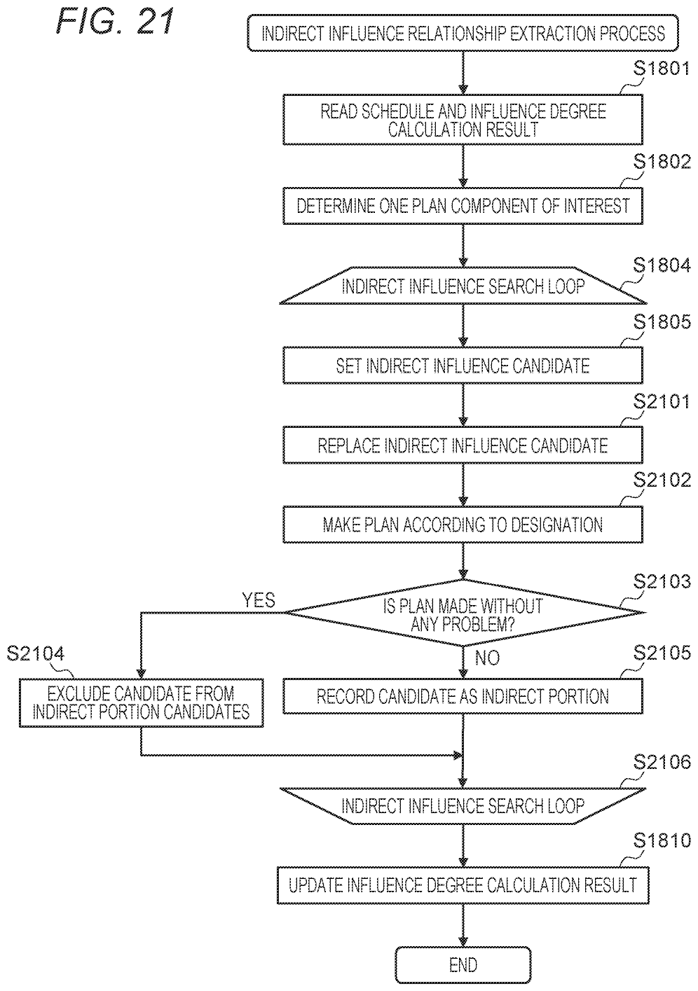

FIG. 21 is a flowchart illustrating an example of a processing procedure of a second indirect influence relationship extraction process. The second indirect influence relationship extraction process is a process of extracting an indirect influence relationship after planning a schedule based on the second approach, and is executed by the plan generation control unit 1701 and the indirect influence relationship calculation unit 1702 after the end of the influence degree calculation process of FIG. 5 or FIG. 15 described in the first embodiment. In FIG. 21, the same processes as those of the indirect influence relationship extraction process of FIG. 18 are denoted by the same step numbers, and detailed descriptions thereof are omitted.

According to FIG. 21, first, the indirect influence relationship calculation unit 1702 executes the processes of steps S1801, S1802, S1804, and S1805 in the same manner as in FIG. 18.

Next, in indirect influence search loop processing, the indirect influence relationship calculation unit 1702 replaces an indirect influence candidate in a target schedule with a target item existing in the same component in a reference schedule (step S2101).

Next, the indirect influence relationship calculation unit 1702 instructs the plan generation control unit 1701 such that a plan component of interest and the indirect influence candidate (that is, the target item of the reference schedule) replaced in step S2101 appear in a final output (that is, a schedule planned by the plan generation unit 1031) of the plan generation unit 1031, and the plan generation control unit 1701 causes the plan generation unit 1031 to make a simulated plan according to the above instruction (step S2102). Note that a control method related to the instruction and planning by the plan generation control unit 1701 depends on an algorithm of the plan generation unit 1031.

Next, the indirect influence relationship calculation unit 1702 confirms a schedule output in step S2102, and determines whether the plan has been made without any problem (step S2103). In the determination in step S2103, specifically, it is confirmed whether or not there occurs an abnormality that a program error has occurred without outputting the schedule, that a designated component has not been output, or that a plan not satisfying a constraint condition, which has been observed in usual outputs, has been output.

If the above-described abnormality has not been confirmed in step S2103 and a schedule as usual has been generated (YES in step S2103), it means that there is no problem (no influence) even if the indirect influence candidate replaced in step S2101 is removed, so that the indirect influence relationship calculation unit 1702 excludes the plan component set in step S1805 from indirect influence candidates (step S2104).

On the other hand, if the above-described abnormality has been confirmed in step S2103 (NO in step S2103), it means that the plan component of interest does not appear either if it is difficult to output the indirect influence candidate replaced in step S2101, so that the indirect influence relationship calculation unit 1702 determines that there is an indirect influence relationship and records the indirect influence candidate set in step S1805 in a predetermined recording destination (step S2105). That is, the indirect influence candidate recorded in step S2105 corresponds to the plan component (indirect influence component) that indirectly affects the change of the KPI with respect to the plan component of interest.

After step S2104 or step S2105, the indirect influence relationship calculation unit 1702 repeatedly executes the loop processing from steps S1804 to S2104 (or S2105) until reaching a predetermined search upper limit related to the search for the indirect influence candidate (step S2106), and proceeds to step S1810 after the end of the loop processing. Note that the predetermined search upper limit related to the search for the indirect influence candidate may be determined, for example, using a calculation time or a threshold of an influence degree of a candidate component.

In step S1810, the influence degree calculation result 1025 read in step S1801 is updated by adding a search result (specifically, the indirect influence candidate recorded in step S2105) of the indirect influence relationship thereto in the same manner as in step S1810 in FIG. 18, thereby ending the indirect influence relationship extraction process.

The indirect influence relationship extraction processes according to the first approach and the second approach have been described as above. In the second embodiment, it is possible to assist appropriate planning by selectively using these approaches according to a feature of a plan.

That is, in a case where there are many combinations of plan components and a schedule of a different pattern is planned each time a user (developer) presses a plan creation button, there is randomness in plan generation. In such a case, however, it is possible to obtain information for appropriate planning even though there is randomness by adopting the first approach is adopted and searching for an indirect influence relationship between plan components (indirect influence relationship) using a plan (historical schedule) that has been already made.

Further, in a case where it takes time to make one schedule due to a complicated configuration or the like, it is difficult to generate a plan a plurality of times. In such a case, the second approach is adopted, and an indirect influence relationship between the plan components (indirect influence relationship) is searched for using a schedule planned based on an explicit instruction, so that it is possible to extract a component essential to generate a plan component of interest (component that should not change randomly) and to contribute to appropriate planning with the analysis of the influence relationship. Note that the above explicit instruction may be given by the user (developer).

What is claimed is:

1. A plan evaluation apparatus that evaluates a schedule planned by combining a plurality of plans, the plan evaluation apparatus comprising:
a feature conversion unit that divides the schedule into plan components based on a predetermined conversion rule, and convert the divided plan components into features;
a model learning unit that uses the features as an input and creates a machine learning model having a key performance indicator (KPI) of the schedule as an objective variable;
a contribution rate calculation unit that calculates a contribution rate of each of the features with respect to the machine learning model; and
an influence degree calculation unit that calculates an influence degree of influence, on the KPI of the schedule, of the plan component which is a conversion source of the feature, based on the contribution rate of the feature.

2. The plan evaluation apparatus according to claim 1, wherein
the feature conversion unit converts the divided plan components into the features based on a plurality of the conversion rules,
the model learning unit creates a plurality of the machine learning models for the features converted based on each of the conversion rules,
the contribution rate calculation unit calculates contribution rates of the features in each of the machine learning models, and
the influence degree calculation unit superimposes the features for which the contribution rates have been calculated to be high in the respective machine learning models to calculate the influence degree, and extracts the plan components that are conversion sources of the superimposed features.

3. The plan evaluation apparatus according to claim 2, wherein
the feature conversion unit obtains the feature by dividing the schedule into plan components based on the conversion rule by any method, and compressing and converting an item value of the plan component into a numerical value or a category value for each of the divided plan components.

4. The plan evaluation apparatus according to claim 1, wherein
the influence degree calculation unit distributes the contribution rates of the features calculated by the contribution rate calculation unit to the plan components, which are the conversion sources of the respective features, and superimposes the features for which the contribution rates have been calculated to be high in the respective machine learning models using the distributed contribution rates to calculate the influence degree.

5. The plan evaluation apparatus according to claim 2, wherein
the model learning unit integrates the plurality of created machine learning models,
the contribution rate calculation unit calculates contribution rates of the features from an integration model integrated by the model learning unit, and
the influence degree calculation unit distributes the contribution rates of the features in the integration model calculated by the contribution rate calculation unit to the plan components, which are the conversion sources of the respective features, and superimposes the distributed contribution rates for each of the plan components to calculate the influence degree.

6. The plan evaluation apparatus according to claim 1, wherein
the schedule includes a target schedule for which the influence degree is calculated and a reference schedule to be compared with the target schedule, and
in a case where a difference between the target schedule and the reference schedule is to be evaluated and there is no conflict between the target schedule and the reference schedule even if a first feature in the target schedule converted by the feature conversion unit and a second feature in the reference schedule converted by the feature conversion unit are exchanged for plan components causing the difference,
the influence degree calculation unit calculates, for each of the plan components causing the difference, a combination of the contribution rates in the target schedule and the reference schedule when the plan components have been exchanged, to calculate the influence degree based on the plan component.

7. The plan evaluation apparatus according to claim 1, wherein
when the schedule has a plurality of KPIs, the influence degree calculation unit calculates a plurality of the influence degrees with respect to respective KPIs, and adding up the influence degrees based on weightings of the respective KPIs to calculate an influence degree with respect to a whole of the plurality of KPIs.

8. The plan evaluation apparatus according to claim 1, wherein
the feature conversion unit divides the schedule into plan components based on the conversion rule automatically created based on values of items included in the schedule or a range of the values, and converts each of the divided plan components into the feature.

9. The plan evaluation apparatus according to claim 1, wherein
the feature conversion unit divides the schedule into plan components based on the conversion rule that is designated by a user and is unique, and converts each of the divided plan components into the feature.

10. The plan evaluation apparatus according to claim 1, further comprising:
a plan generation unit that plans the schedule by a predetermined algorithm to satisfy a given condition.

11. The plan evaluation apparatus according to claim 1, further comprising:
an indirect influence relationship calculation unit that extracts an indirect influence component meaning a plan component, which indirectly contributes to a change of the KPI, from the schedule for which the influence degree on the KPI has been calculated by the influence degree calculation unit based on a dependence relationship between the plan components in the schedule.

12. The plan evaluation apparatus according to claim 11, wherein
the schedule includes a target schedule for which the influence degree is calculated and a historical schedule which has been made separately from the target schedule, and
the indirect influence relationship calculation unit determines one plan component of interest out of plan components of the target schedule for which the influence degree on the KPI has been calculated by the influence degree calculation unit, searches for a plan component that appears simultaneously with the plan component of interest in the historical schedule having the plan component of interest, and determines and extracts the plan component found in the search as the indirect influence component for the plan component of interest.

13. The plan evaluation apparatus according to claim 11, further comprising:
a plan generation unit that plans the schedule by a predetermined algorithm to satisfy a given condition; and
a plan generation control unit that instructs the plan generation unit to plan the schedule, wherein
the schedule includes a target schedule for which the influence degree is calculated and a reference schedule to be compared with the target schedule,
the indirect influence relationship calculation unit determines one plan component of interest out of plan components of the target schedule for which the influence degree on the KPI has been calculated by the influence degree calculation unit, sets a plan component different from the plan component of interest as an indirect influence candidate, and further replaces the indirect influence candidate with a plan component corresponding to the indirect influence candidate of the reference schedule,
the plan generation control unit instructs the plan generation unit to plan a simulation schedule having the plan component of interest and the replaced indirect influence candidate, and
when a problem occurs in planning of the simulation schedule by the plan generation unit, the indirect influence relationship calculation unit determines and extracts the indirect influence candidate before the replacement as the indirect influence component for the plan component of interest.

14. The plan evaluation apparatus according to claim 1, further comprising:
a screen output unit that causes an output apparatus to display a calculation result of the influence degree by the influence degree calculation unit, wherein
the screen output unit highlights a plan component for which a large influence degree exceeding a predetermined reference has been calculated among a plurality of the plan components for which the influence degree has been calculated by the influence degree calculation unit in displaying the calculation result.

15. A plan evaluation method by a plan evaluation apparatus, which evaluates a schedule made by combining a plurality of plans, the plan evaluation method comprising:
a feature conversion step of dividing, by the plan evaluation apparatus, the schedule into plan components based on a predetermined conversion rule, and convert the divided plan components into features;
a model learning step of receiving, by the plan evaluation apparatus, an input of the feature converted in the feature conversion step and creating a machine learning model having a key performance indicator (KPI) of the schedule as an objective variable;
a contribution rate calculation step of calculating, by the plan evaluation apparatus, a contribution rate of each of the features with respect to the machine learning model created in the model learning step; and
an influence degree calculation step of calculating, by the plan evaluation apparatus, an influence degree of influence, on the KPI of the schedule, of the plan component which is a conversion source of the feature, based on the contribution rate of the feature calculated in the contribution rate calculation step.
